(19) United States
(12) Patent Application Publication
(10) Pub. No.: US 2009/0249705 A1
(43) Pub. Date: Oct. 8, 2009

(54) Mounting Receivers with Spackling Rim Gradient

(75) Inventors: Scott Struthers, San Clemente, CA (US); Ray Call, Mission Viejo, CA (US); Geoff Spencer, San Juan Capistrano, CA (US); Greg Fetter, Capistrano Beach, CA (US)

Correspondence Address: FISH & ASSOCIATES, PC;ROBERT D. FISH, 2603 Main Street, Suite 1000, Irvine, CA, 92614-6232, US

(73) Assignee: TRUFIG, San Clemente, CA (US)

(21) Appl. No.: 12/427,591

(22) Filed: Apr. 21, 2009

Related U.S. Application Data
(63) Continuation-in-part of application No. 12/202,870, filed on Sep. 2, 2008.
Application No. 12/202,870 is a continuation-in-part of application No. 11/954,667, filed on Dec. 12, 2007, now Pat. No. 7,461,483.
Application No. 11/954,667 is a continuation-in-part of application No. 11/566,365, filed on Dec. 4, 2006.
Application No. 11/566,365 is a continuation-in-part of application No. PCT/US07/16404, filed on Jul. 19, 2007.
(60) Provisional application No. 60/950,237, filed on Jul. 17, 2007.
(60) Provisional application No. 60/950,237, filed on Jul. 17, 2007.

(51) Int. Cl. E04F 19/00; E04B 1/00; G01C 9/00

(52) U.S. Cl. 52/27; 52/741.1; 33/290

(57) ABSTRACT

A panel with a receiver is used to install a component into a wallboard. The panel is inserted into an opening into a wallboard, and the junction between the panel and the wallboard is taped and spackled so that the wallboard and panel appear to be a single surface. A spackle rim with a gradient extending from the spackle rim along the surface of the panel is used so that spackle can be spread thinly across the entire surface of the panel.

This application is a continuation-in-part of non-provisional application Ser. No. 12/202,870 filed Sep. 2, 2008 which is a continuation-in-part of non-provisional application Ser. No. 11/954,667 filed Dec. 12, 2007 which is a continuation-in-part of non-provisional application Ser. No. 11/566,365 filed Dec. 4, 2006 and claims priority to provisional application ser. No. 60/950,237 filed Jul. 17, 2007 and is a continuation-in-part of International application ser. no. PCT/U.S.07/16404 filed Jul. 19, 2007 which claims priority to 60/258,162 filed Sep. 11, 2006 and claims priority to 60/950,237 filed Jul. 17, 2007. All prior applications are incorporated by reference in their entirety.

### FIELD OF THE INVENTION

The field of the invention is spackle rims for wall mounts.

### BACKGROUND

Plasma screens, speakers, light switches, electrical outlets, recessed lighting, junction boxes and other components are conventionally mounted to walls or ceilings. In order to install these components into a wall or ceiling, a cutout is typically performed at the job site, and the component is inserted into the cutout. Conventional installations invariably produce a gap between wall or ceiling and the component being installed, which is usually covered with a flange installed over both the component and the wallboard. Flanges can be relatively small, as in the case of flanges used around the edges of the electrical boxes for ceiling lights and speakers, or relatively large, as in the case of face plates for electrical outlets, light switches or other in-wall controls. The use of flanges to cover a gap between a component and a wallboard, however, can be unsightly and could cause the component to be more noticeable since flanges commonly extend from wallboard surfaces. A component could not be completely visibly integrated with the wallboard with a flange bulging from the front surface of the wallboard.

WO 2008/119180 to Arbel teaches an electrical outlet box installation with an angled flange that extends from a component over a wallboard surface. The flange is then hidden from view with a spackling paste that covers both the flange and the surrounding wallboard. Arbel, however, creates an unsightly bulge from the wall since a flange that covers a wallboard necessarily extends outwards from a surface of the wallboard. Arbel and all other extrinsic materials identified herein are incorporated by reference in their entirety. Where a definition or use of a term in an incorporated reference is inconsistent or contrary to the definition of that term provided herein, the definition of that term provided herein applies and the definition of that term in the reference does not apply.

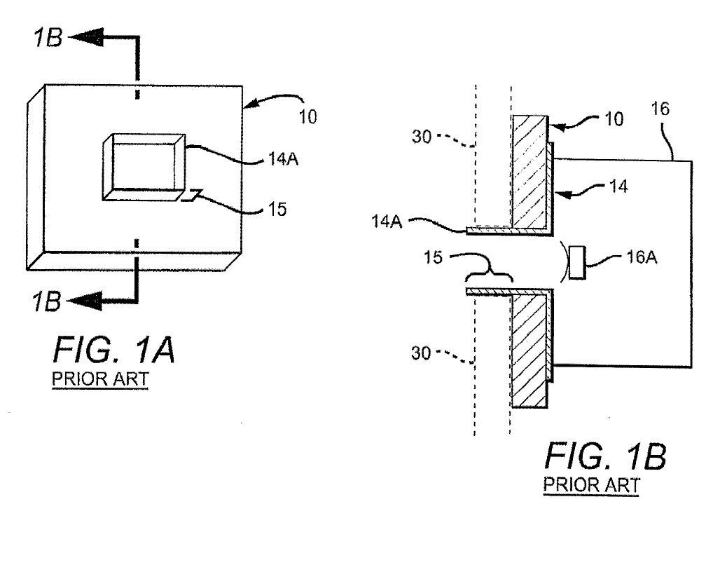

It is also known to install wall and ceiling component using flangeless installations. In prior art FIGS. 1A and 1B, for example, a panel 10 is placed behind the wallboard 30. The speaker housing 16 extends out the back side of the panel 10 (i.e. inside the wall or ceiling), and a receiver 14 coupled to the panel 10 has a rim portion 14A that extends above (on the front side of the wall or ceiling) the panel 10 by a distance 15. The drywaller then cuts a hole in wallboard 30 up to the edge of the rim 14. Additional examples are discussed in U.S. Pat. No. 7,032,708 to Popken et al. (April 2006), and U.S. Pat. No. 7,296,280 to Richie (October 1981).

U.S. Pat. No. 6,217,189 to Nassim provides a ceiling tile with wedge-shaped edges that provide a beveled spackling surface. An installer could install Nassim's ceiling tile into an opening in a ceiling wallboard so that the edges are slightly recessed from a front surface of the wallboard. The installer could then tape and spackle over the recessed wedge-shaped edges with a joint compound. Since only the edges are spackled, however, a discerning observer could easily notice that the front surface of the ceiling tile has a different look and feel than the front surface of the rest of the wallboard. A component could not be completely visibly integrated with the wallboard when the texture of the component surface differs greatly from the rest of the wallboard.

Thus, there is still a need in the art for improved flush-mounting systems that provide a smooth, uniform surface after spackling.

### SUMMARY OF THE INVENTION

The present invention provides apparatus and methods in which a spackle gradient extends outwards along the surface of a panel from a panel opening in the panel. Since most of the front surface of the panel is slightly recessed from the panel opening, an installer could cover the entire surface of the panel with a joint compound. Contemplated gradients could extend across the entire surface of the panel, but preferably levels off at least 10 mm, 20 mm, 30 mm, 40 mm, or even at least 50 mm. In this instance, and where other upper limits are not expressly stated, the reader should infer a reasonable upper limit. In this instance, for example, a commercially reasonable upper limit is about 2 meters. The gradient could be an even linear gradient sloping from the panel opening, but is preferably curved and levels off to provide a steep gradient close to the panel opening and a slight gradient further from the panel opening.

The panel opening has a spackle rim along one of its edges, which is preferably the thickest portion of the panel. A spackle rim could have a single edge, for example in the shape of a half-circle along an edge of the panel, two edges, for example in the shape of a triangle along an edge of the panel, three edges, four edges, or more. Preferably the spackle rim forms a rectangle in the middle of the panel, and is of uniform thickness along all of its edges. While the spackle rim is preferably integrated into the panel as the top edge of the gradient, the spackle rim could be a separate receiver component that extends from the inner perimeter of the panel opening without departing from the scope of the invention. After the panel is placed within a wallboard opening in the wallboard, an installer can spread a spackle component across the entire spackle gradient up to the spackle rim to maintain a superficially continuous surface from the wallboard to the spackle rim.

The receiver could be coupled to the opening or another support structure so as to hold the component firmly in place within the panel opening. Preferably, the receiver is more than merely a rim, and has an extensive housing extending out the back of the panel to hold a large component. The receiver could be coupled to the opening in any suitable manner, for example clamping the receiver around a front side and a back side of the opening, using screws, glue, nails, latches, locks, and hook and loop fasteners. Preferably, the front of the receiver has an optional spackle shield that abuts the spackle rim to prevent spackle from entering the opening during installation. The spackle shield could have a variety of measuring devices that assist an installer, for example a bubble leveler or a laser leveler.

The laser leveler should be aimed in a variety of directions. For example, the laser leveler could shine a beam of light across the front surface of the panel with a width that is substantially perpendicular to the front surface of the wallboard to ensure that the panel is positioned at an appropriate height. As used herein, “substantially perpendicular” means an angle that is within 1 degree of 90 or 270 degrees. Alternatively, the laser leveler could shine a beam of light across the front surface of the panel with a width that is substantially parallel to the front surface of the wallboard. As used herein, “substantially parallel” means an angle that is within 1 degree of 0 or 180 degrees. Preferably, laser light from the laser leveler hits a part of the spackle rim. A laser light that shines across a front surface of the panel and hits the spackle rim would bit any lumps of spackle component that extend outwards beyond the edge of the spackle rim. An installer could then flatten or sand the surface of the spackle component until the laser light disappears. In an exemplary embodiment, the laser leveler could rotate about an axis so as to shine across any front surface of the panel along a path that is substantially perpendicular to the front surface of the wallboard.

Preferred panels have compositions and thicknesses that match the wallboard to which they are being finished, in terms of thickness, composition, and so forth. The panel preferably has a thickness within 20%, 15%, 10%, 5%, or 1% of the wallboard thickness. Where there are differences in composition or thickness, it is preferred that the moisture absorption rate and the thermal expansion rate of the panel and the wallboard differ by no more than 30%, 20%, 10% or 5% from one another to prevent cracking and fraying. Contemplated panel materials include polymers, plasters, woods, fiberboards, and gypsum. Since the panel will likely be anchored to a support structure using a screw, nail, or similar attachment mechanism, preferred panels have a plurality of stud attachment designations, for example depressions, markings, or screw holes, that indicate potential screw or nail positions. Panels can have factory cut openings that receive the multiple receivers, and in such cases the receivers would likely be glued to the panel material to eliminate any gaps. More advantageously, the panel material could be molded around the receivers so that there is essentially no gap between the panel material and the receivers.

Various objects, features, aspects and advantages of the present invention will become more apparent from the following detailed description of preferred embodiments of the invention, along with the accompanying drawings in which like numerals represent like components.

### DETAILED DESCRIPTION

FIG. 1A is a front perspective view of a prior art flush mount speaker panel.

FIG. 1B is a vertical cross-section of the prior art speaker panel taken along line 1B-1B in FIG. 1A, installed in a wall and with an attached speaker.

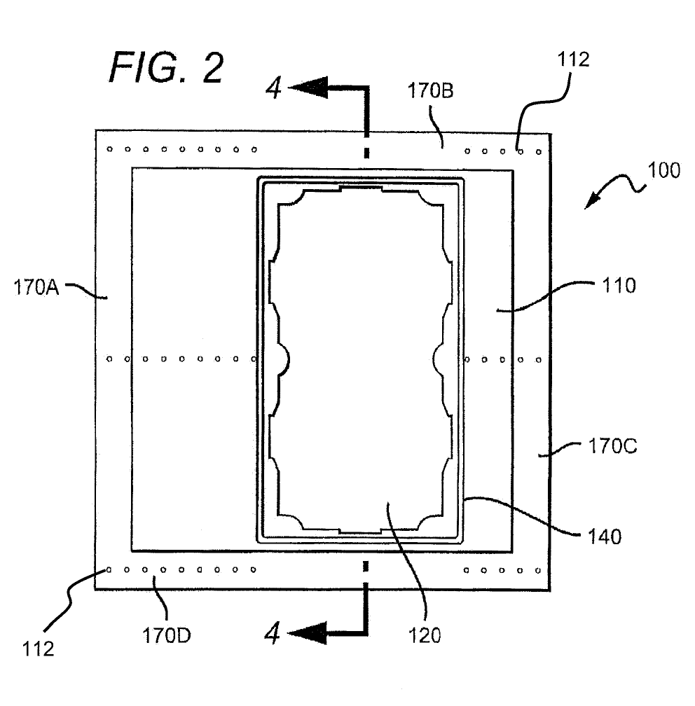

FIG. 2 is a plan view of a panel having a sound opening, and a receiver disposed in the sound opening.

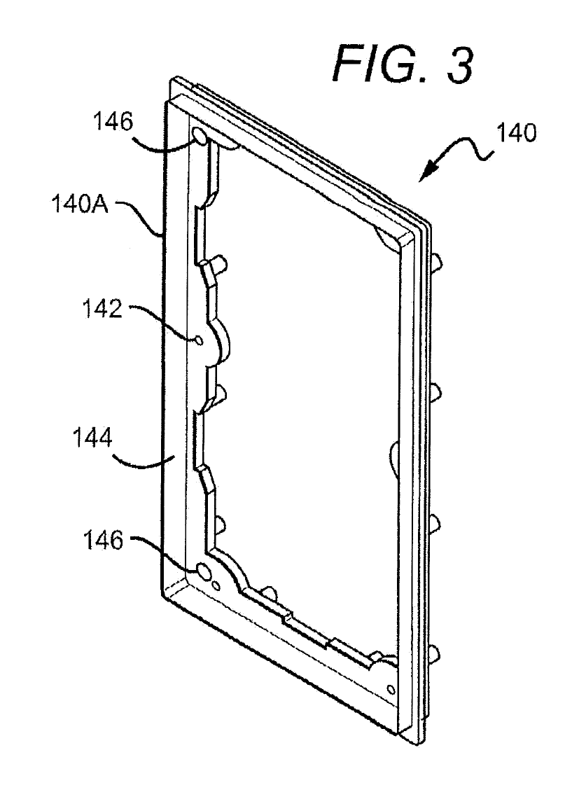

FIG. 3 is a front perspective view of the receiver in FIG. 2.

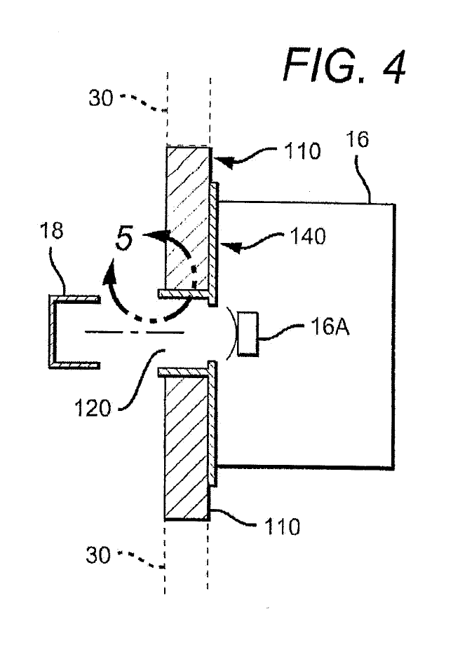

FIG. 4 is a simplified vertical cross-section of the panel and receiver of FIG. 2, taken along line 4-4, installed in a wall and with an attached speaker.

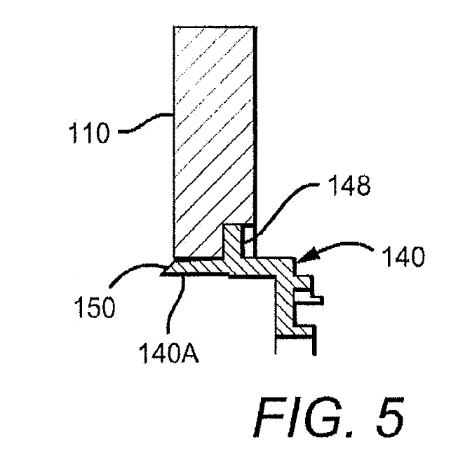

FIG. 5 is a blow up of the circled portion of FIG. 4 along designation 5.

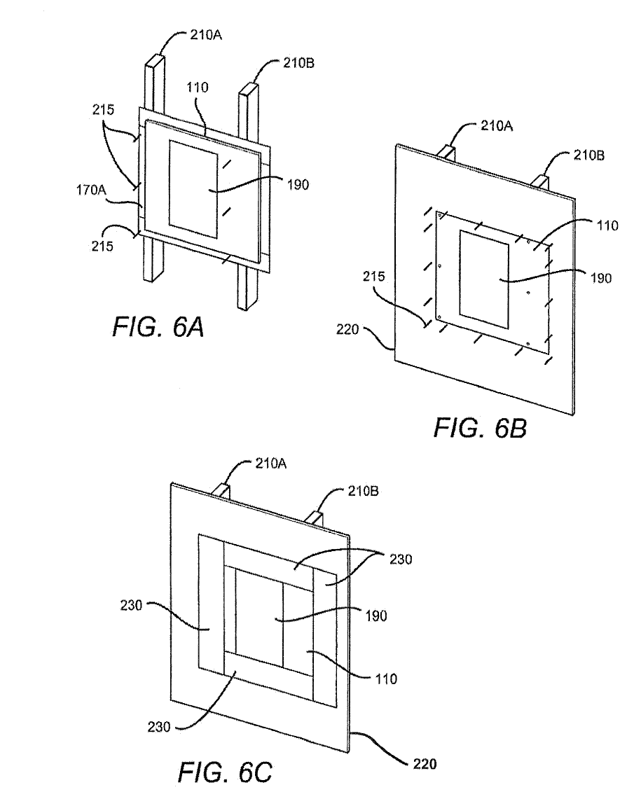

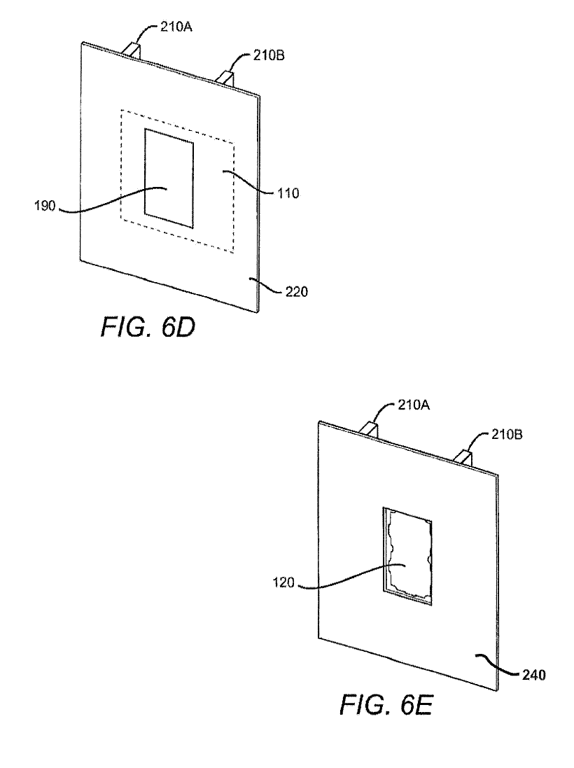

FIG. 6A is a front perspective view of a panel being affixed to two studs in a wall, the panel having a spackle shield covering an opening.

FIG. 6B is a front perspective view of the panel of FIG. 6A, around which drywall has been installed.

FIG. 6C is a front perspective view of the panel and drywall of FIG. 6B, showing mesh tape.

FIG. 6D is a front perspective view of the panel and drywall of FIG. 6C, where the mesh tape has been covered by spackle.

FIG. 6E is a front perspective view of the panel and drywall of FIG. 6C, where the spackle shield has been removed to show the opening.

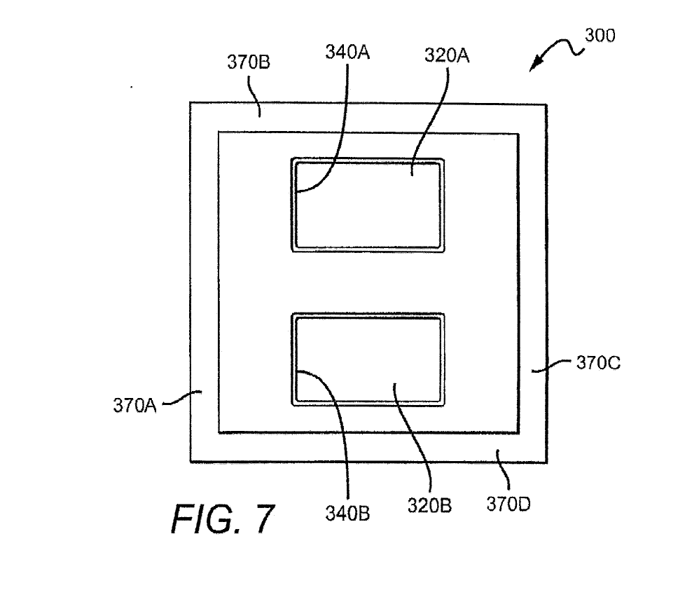

FIG. 7 is a front perspective view of a panel having two speaker openings.

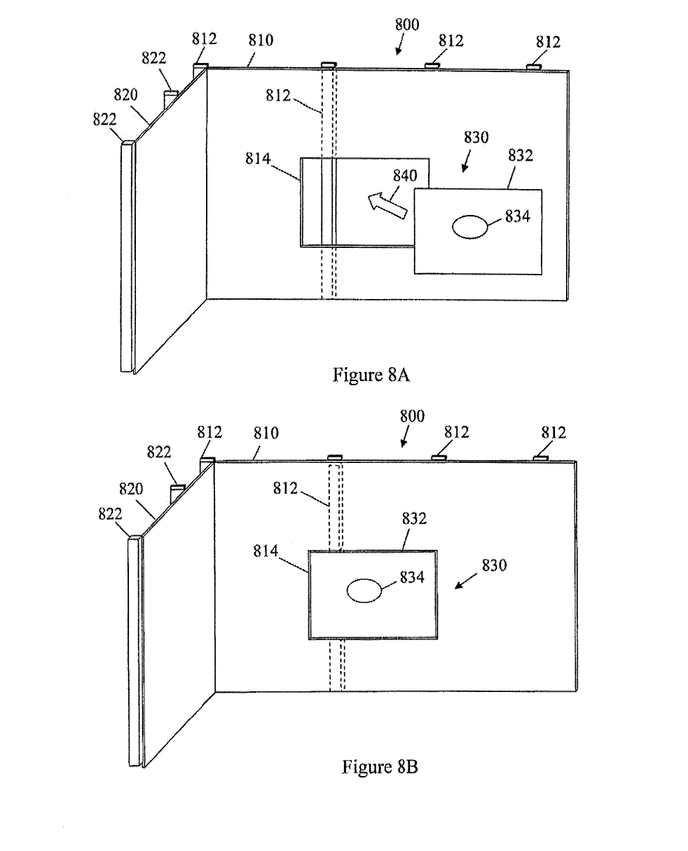

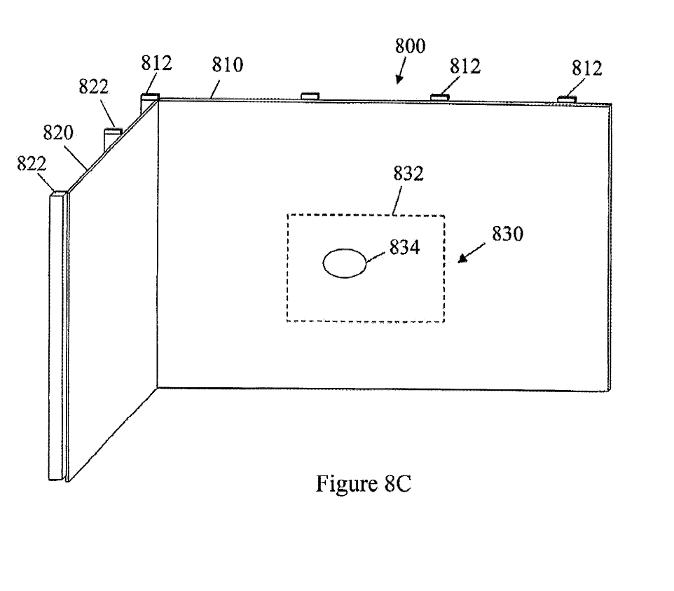

FIG. 8A is a perspective view of two structural components of a building (e.g. walls or wall and ceiling), in which an opening has been cut to receive a panel assembly.

FIG. 8B is a perspective view of the two structural components of FIG. 8A, in which the panel assembly has been placed within the opening.

FIG. 8C is a perspective view of the two structural components of FIG. 8B, in which the approximated edges of the panel assembly and the wall have been finished to provide a superficially continuous junction.

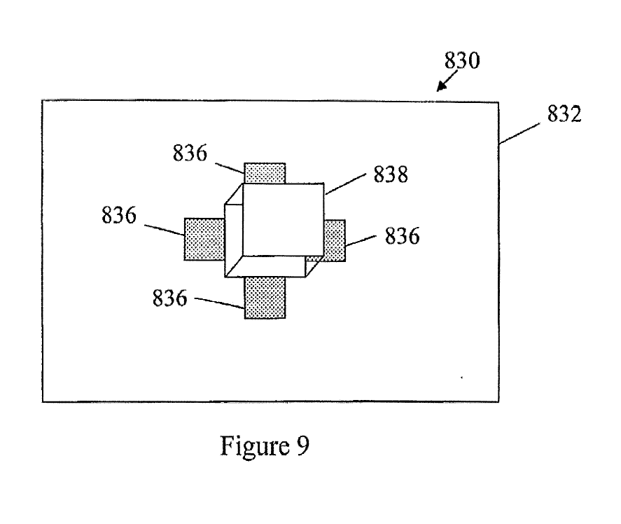

FIG. 9 is a rear view of the panel assembly of FIGS. 8A-8C, showing a receiver and attachments.

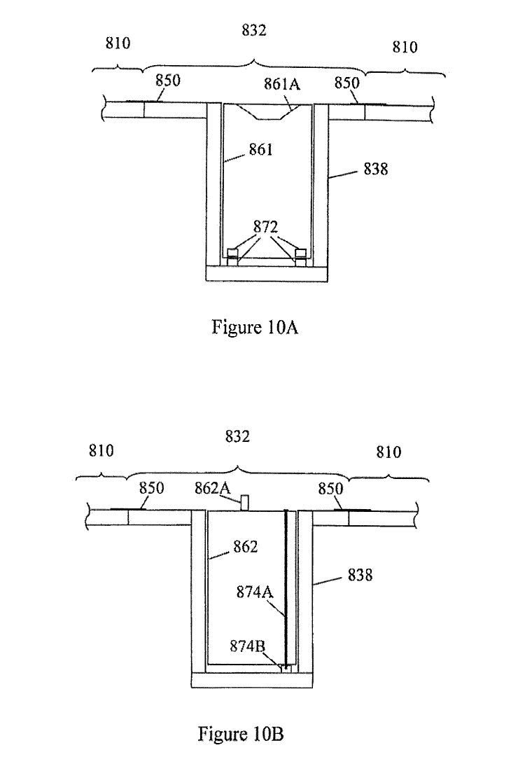

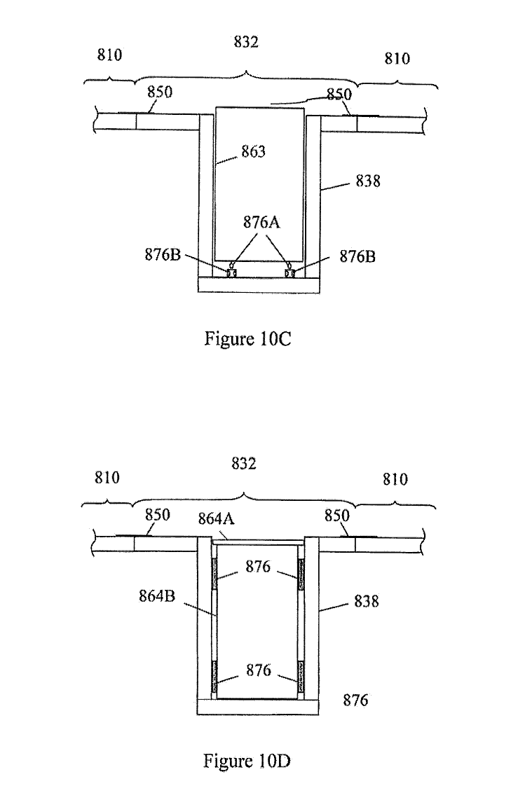

FIG. 10A is a horizontal cross-section of a panel assembly and speaker component installed in a wall, where the component is seated to the assembly using magnets.

FIG. 10B is a horizontal cross-section of a panel assembly and switch component installed in a wall, where the component is seated to the assembly using a long bolt.

FIG. 10C is a horizontal cross-section of a panel assembly and light component installed in a wall, where the component is seated to the assembly using a detent.

FIG. 10D is a horizontal cross-section of a panel assembly and a generic component installed in a wall, where the component is seated to the assembly using friction surfaces.

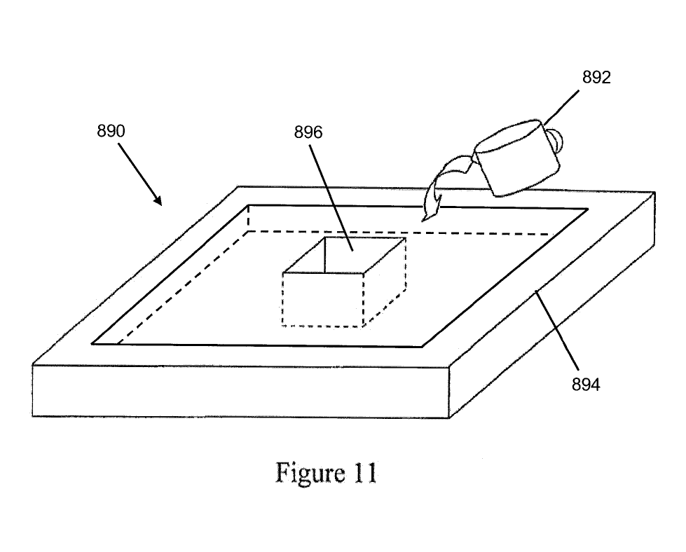

FIG. 11 is a perspective view of a panel assembly being formed by pouring a panel material into a mold.

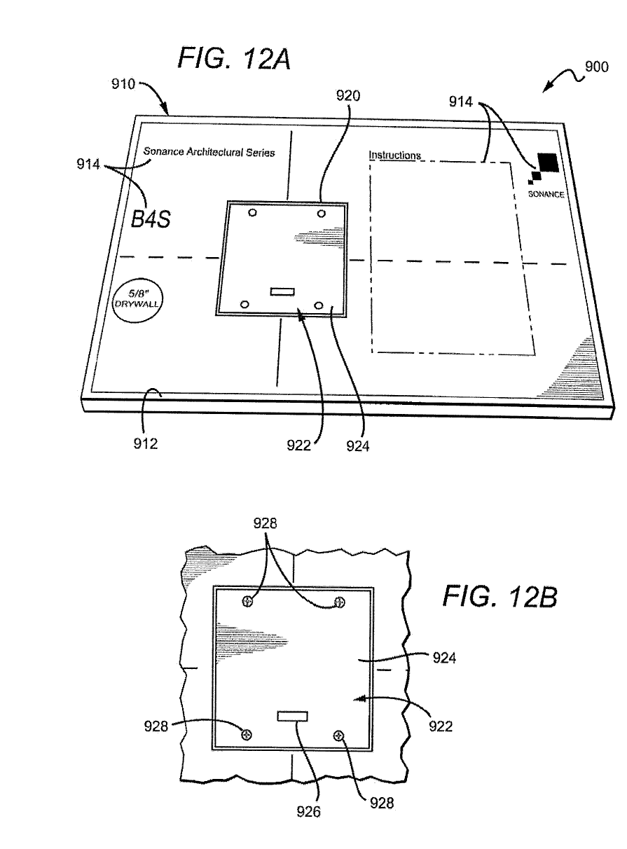

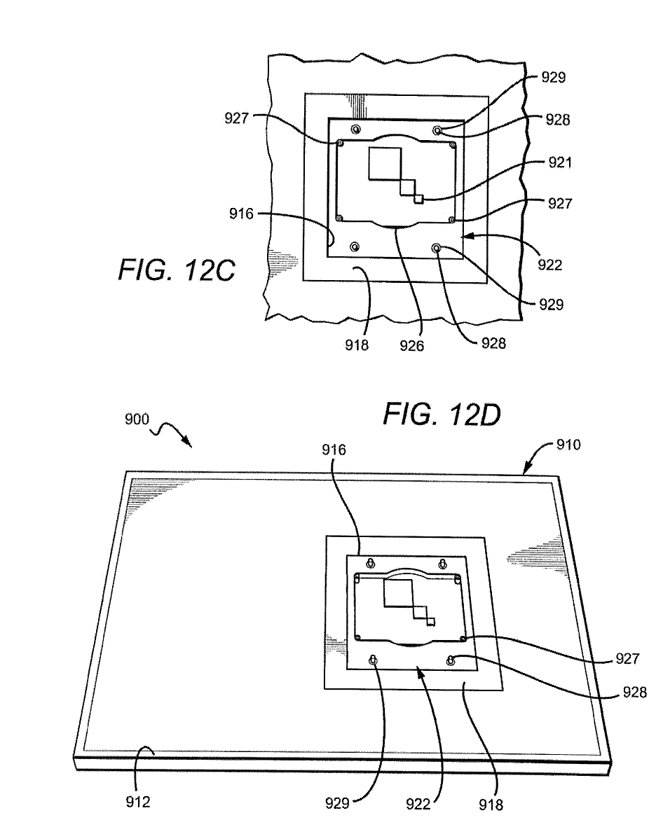

FIGS. 12A and 12B show perspective views of the front of a preferred drywall with a spackle shield.

FIGS. 12C and 12D show the back of the preferred drywall and insert of FIGS. 12A and 12B.

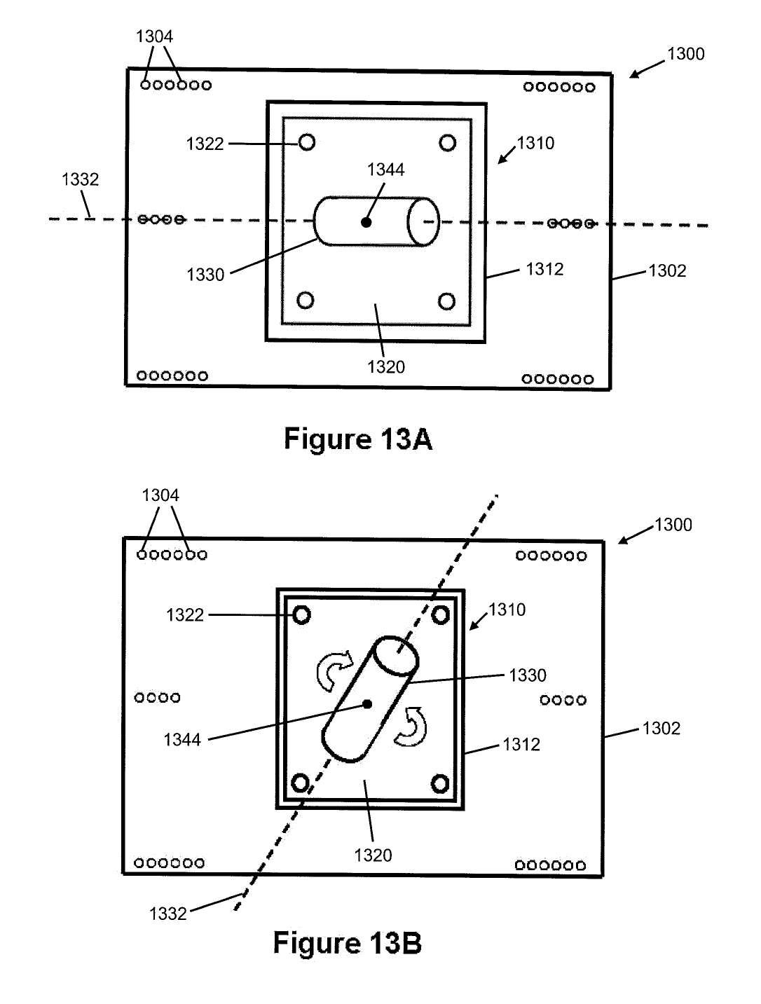

FIG. 13A is a front plan view of a panel assembly with a gradient extending from a spackle rim to an edge of the wallboard.

FIG. 13B is a front plan view of the panel assembly of FIG. 13, with a rotatable laser leveler.

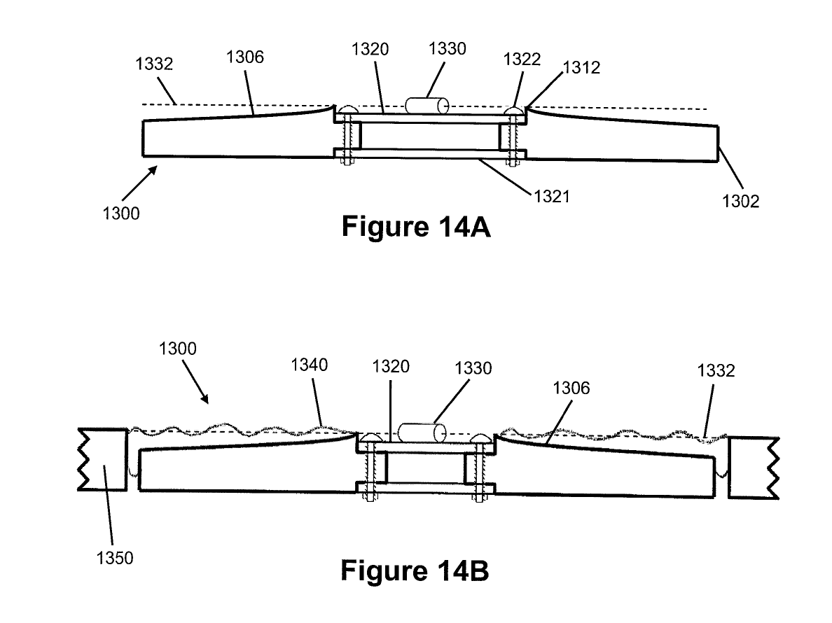

FIG. 14A is a horizontal cross-section of the panel assembly of FIG. 13.

FIG. 14B is a horizontal cross-section of the component panel of FIG. 13 disposed within an opening in a wallboard with spackle spread across the surface of the panel assembly and the wallboard.

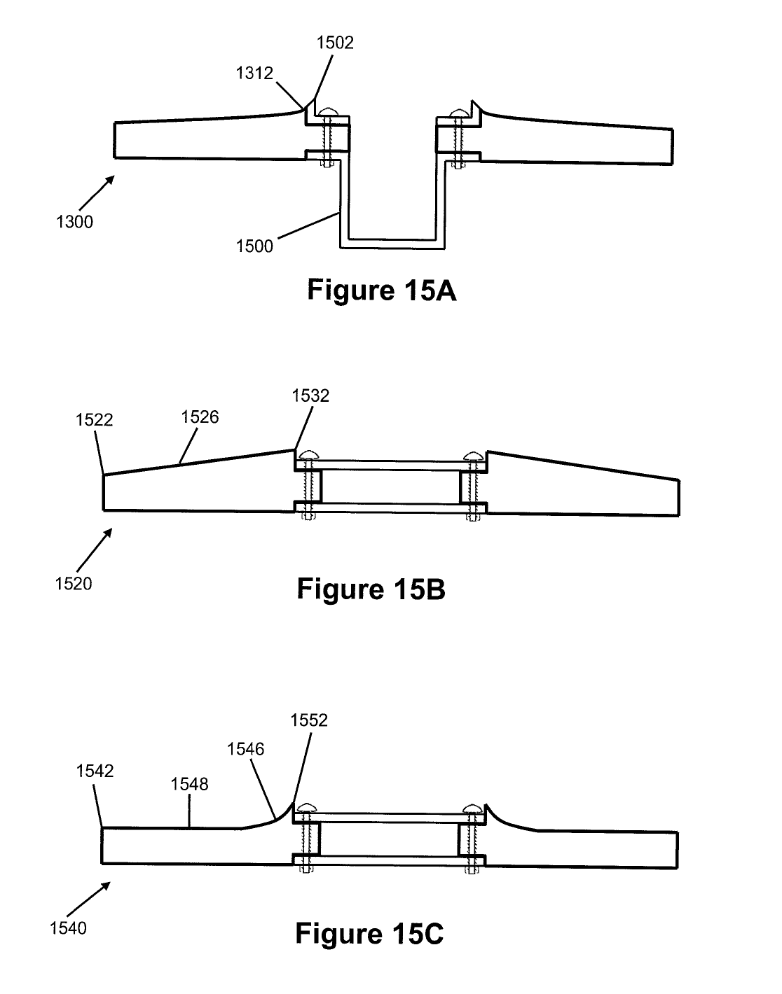

FIG. 15A is a horizontal cross-section of the panel assembly of FIG. 13 with a receiver installed into the panel opening.

FIG. 15B is a horizontal cross-section of an alternative panel assembly with a linear gradient.

FIG. 15C is a horizontal cross-section of an alternative panel assembly with a curved gradient that fails to extend across the surface of the panel to an edge of the panel.

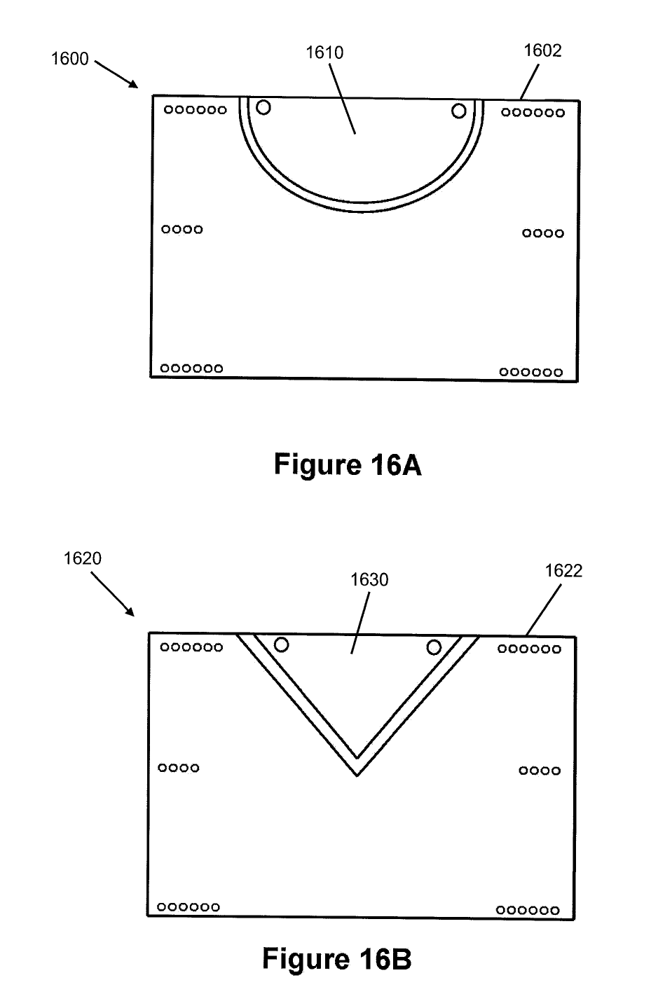

FIG. 16A-16B are alternative panel assemblies with openings along an edge of the wallboard.

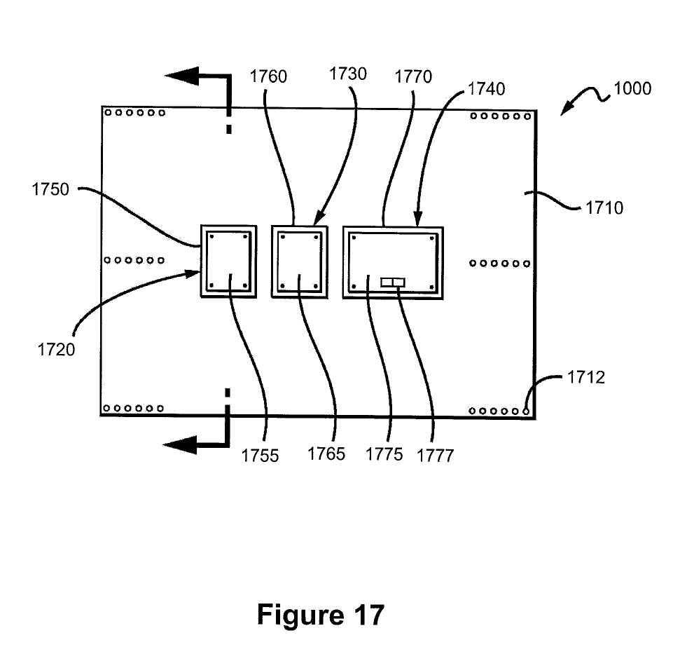

FIG. 17 is a plan view of a panel having three openings, with a receiver disposed within each opening.

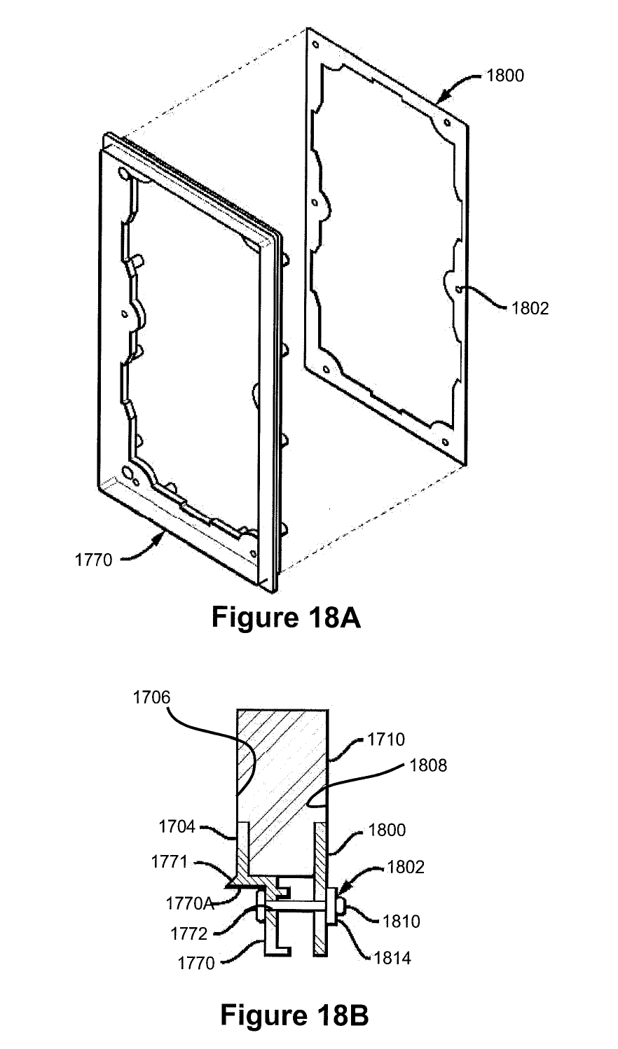

FIG. 18A is a front perspective view of the receiver of FIG. 3 positioned to couple with a receiver backing.

FIG. 18B is a simplified vertical cross-section of the panel of FIG. 2, taken along line 4-4, with the receiver and receiver backing of FIG. 18A.

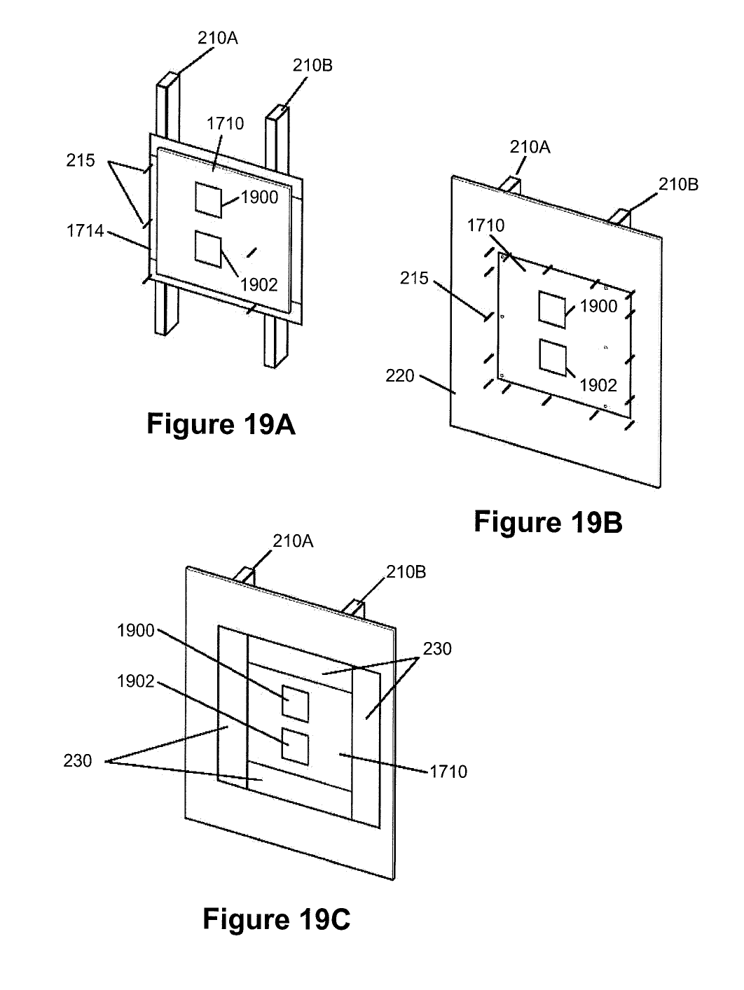

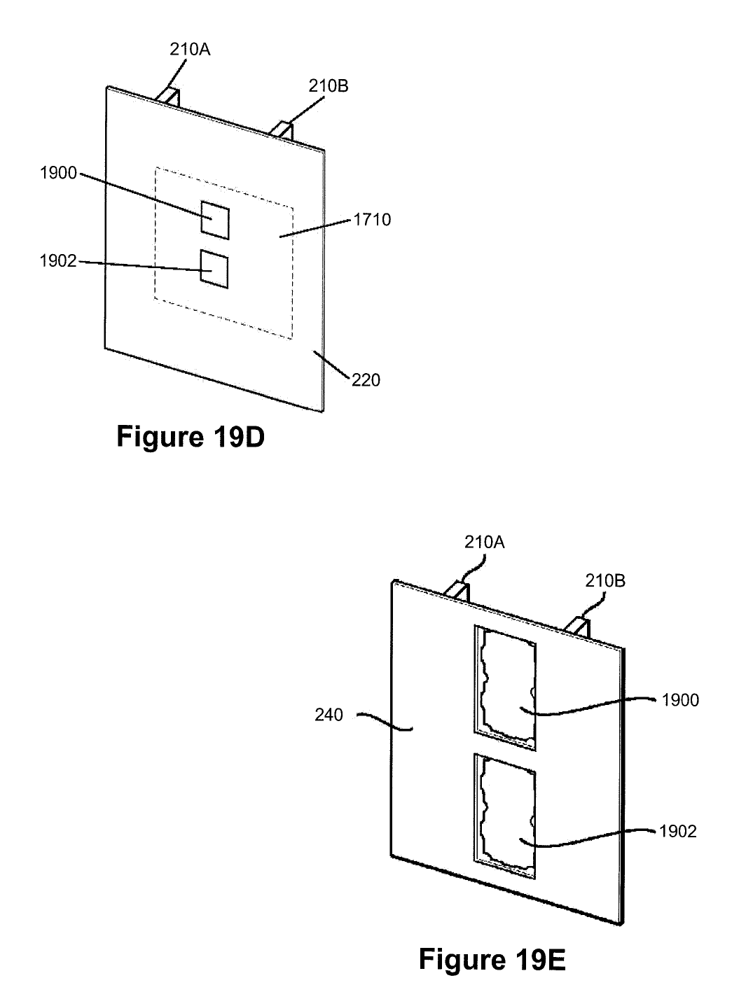

FIG. 19A is a front perspective view of a panel with multiple openings and brackets being affixed to two studs in a wall.

FIG. 19B is a front perspective view of the panel of FIG. 19A, around which drywall has been installed.

FIG. 19C is a front perspective view of the panel and drywall of FIG. 19B, showing mesh tape.

FIG. 19D is a front perspective view of the panel and drywall of FIG. 19C, where the mesh tape has been covered by spackle.

FIG. 19E is a front perspective view of the panel and drywall of FIG. 19C, where the spackle shields have been removed to show the openings.

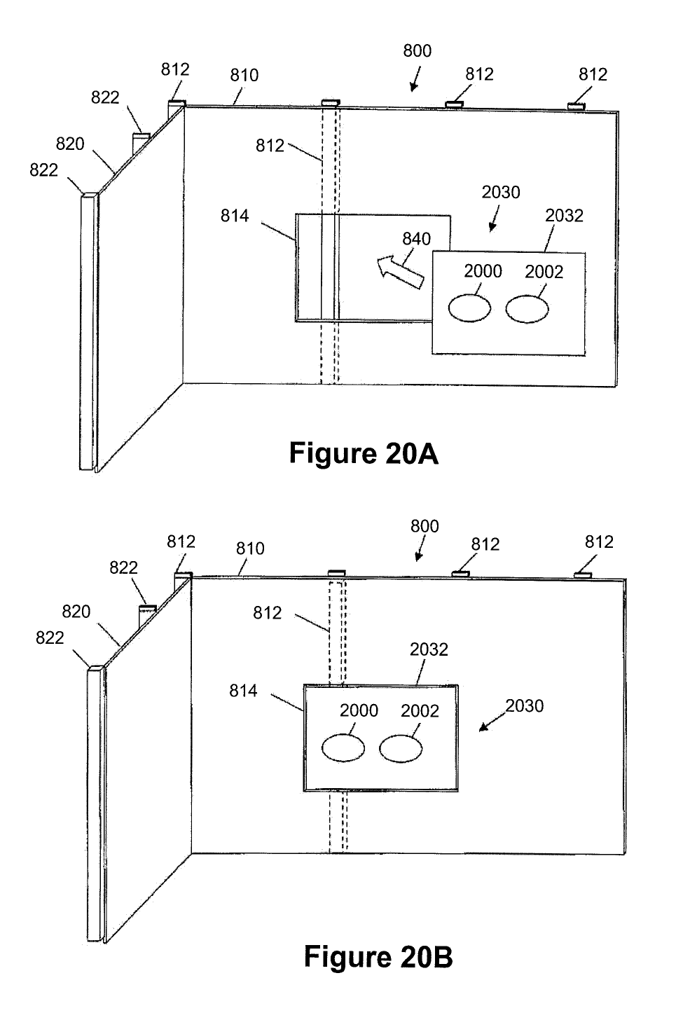

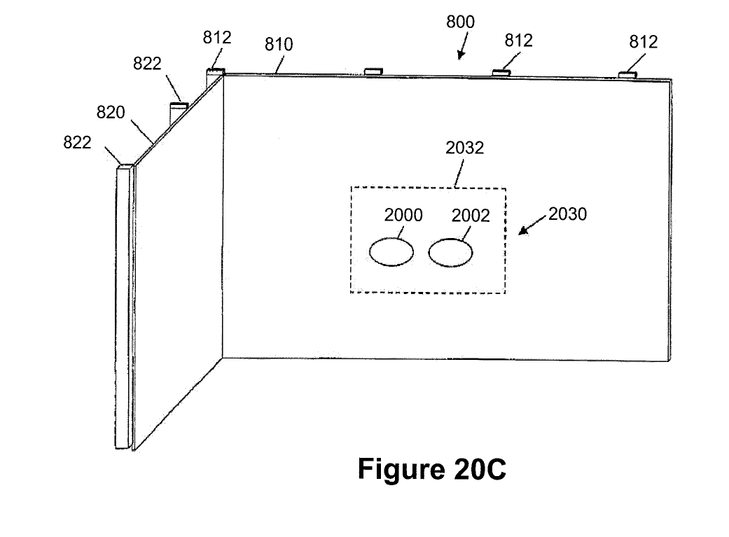

FIG. 20A is a perspective view of two structural components in a building (e.g. walls or wall and ceiling), in which an opening has been cut to receive a panel assembly that has multiple openings and multiple brackets.

FIG. 20B is a perspective view of the two structural components of FIG. 20A, in which the panel assembly has been placed within the opening.

FIG. 20C is a perspective view of the two structural components of FIG. 20B, in which the approximated edges of the panel assembly and the wall have been finished to provide a superficially continuous junction.

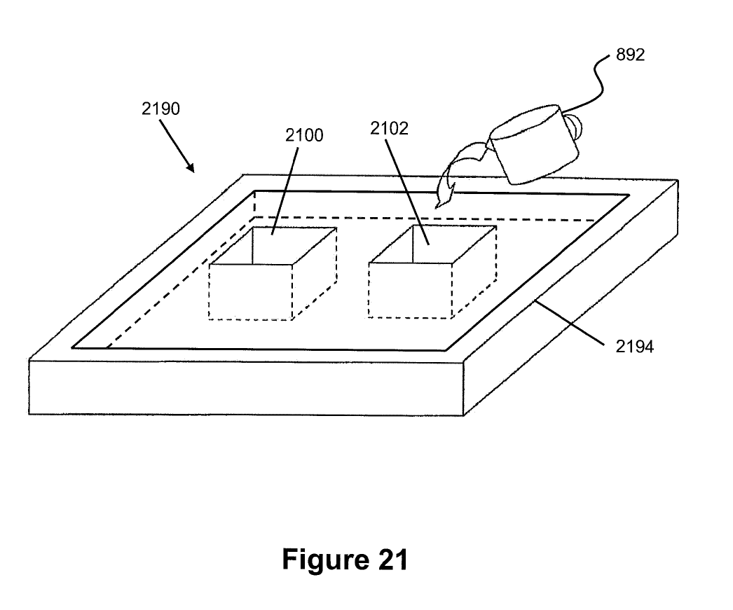

FIG. 21 is a perspective view of a panel assembly with multiple openings being formed by pouring a panel material into a mold.

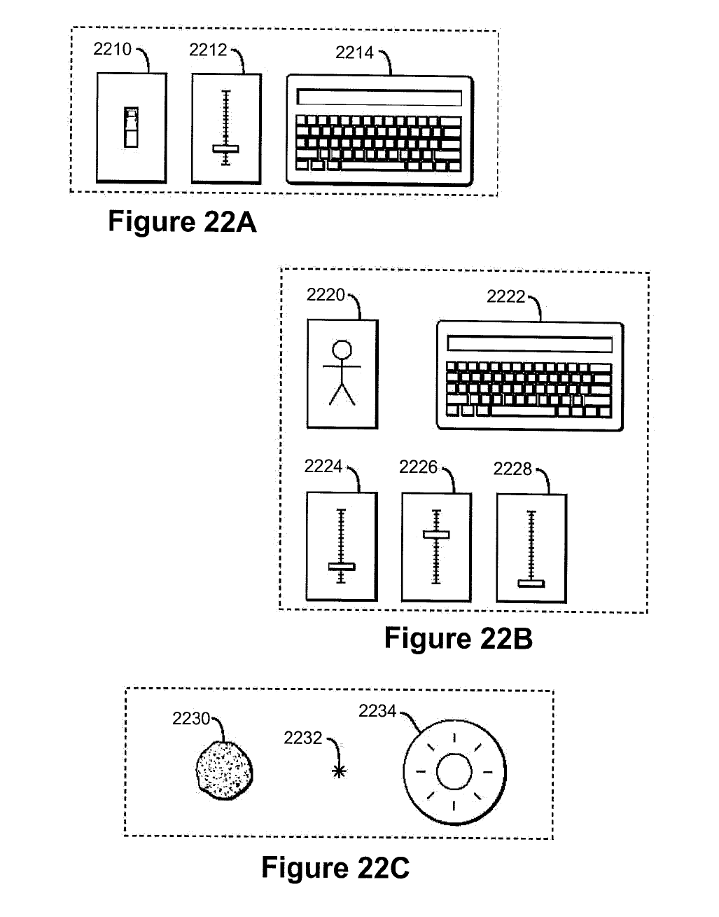

FIG. 22A is a front plan view of a wall with installed components using the panel of FIG. 17.

FIG. 22B is a front plan view of a wall with installed components staggered in an alternative configuration.

FIG. 22C is a front plan view of a ceiling with installed components.

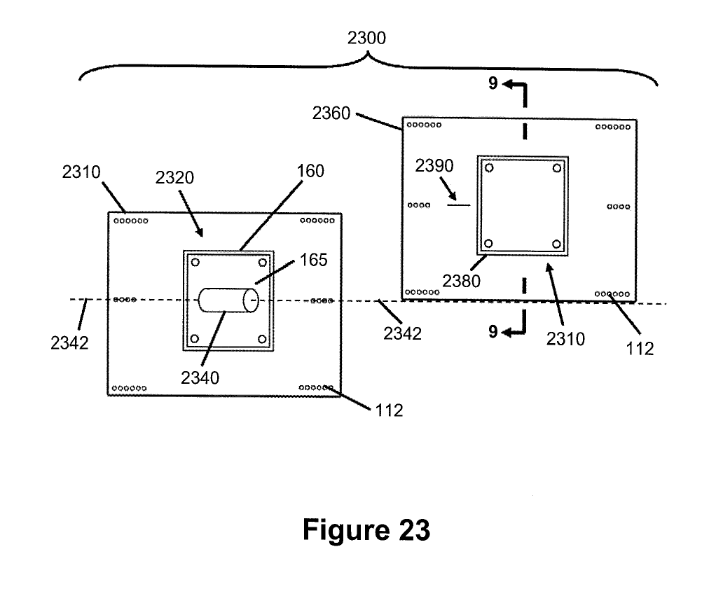

FIG. 23 is a front plan view of a first panel with a laser light and a second panel that is aligned using the laser light.

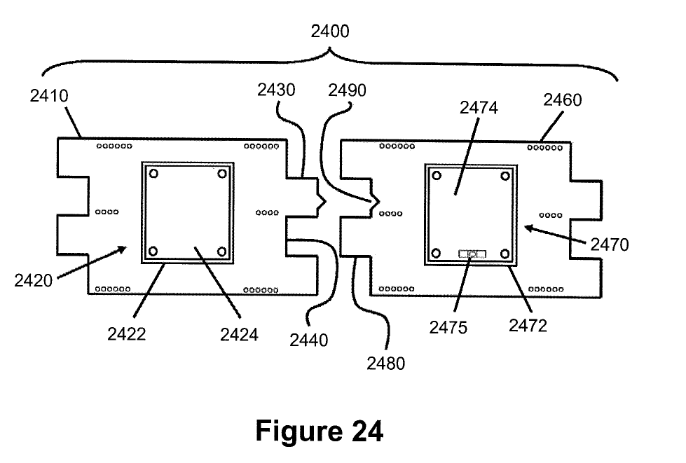

FIG. 24 is a front plan view of two panels with interlocking dovetails.

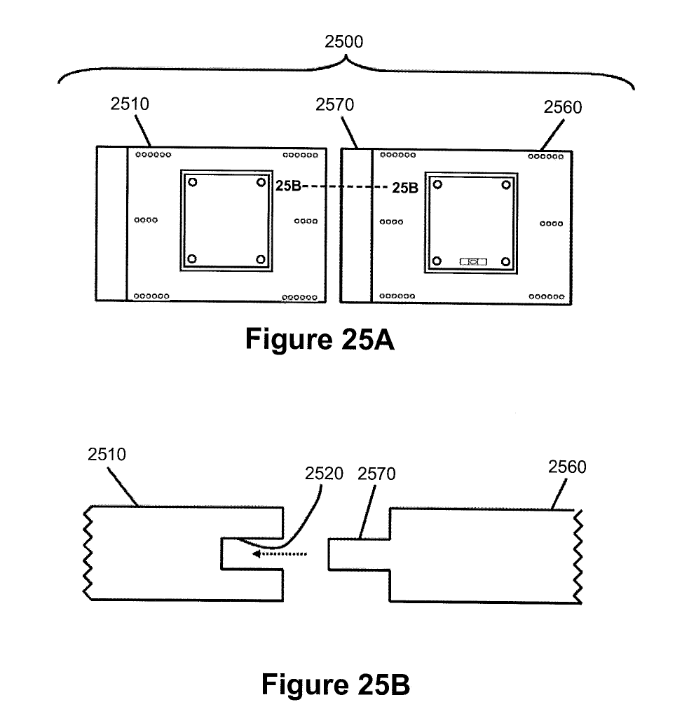

FIG. 25A is a front plan view of two panels with an interlocking tongue and groove.

FIG. 25B is a horizontal cross-section of along line 25B-25B of the panels of FIG. 25A.

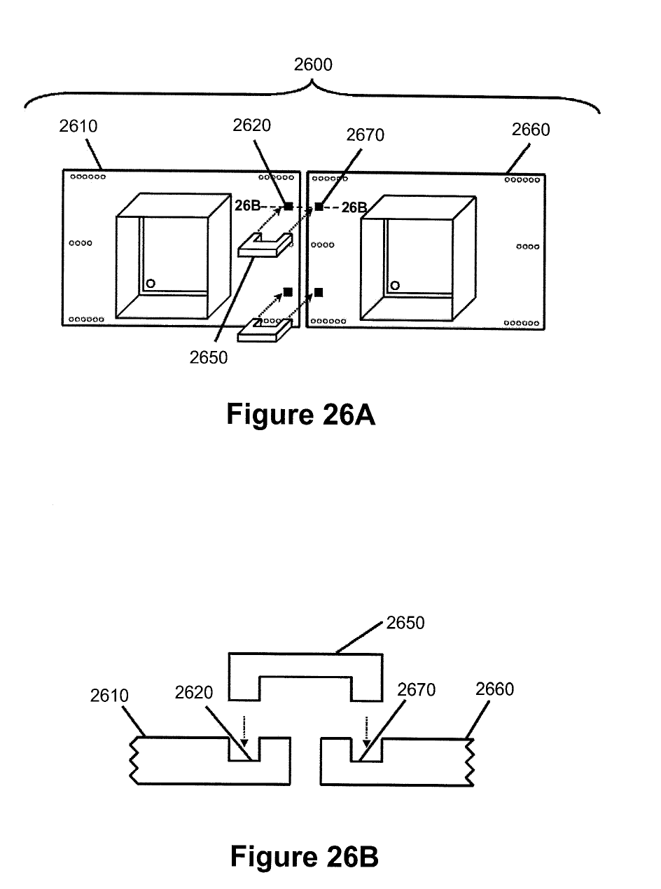

FIG. 26A is a rear plan view of a first panel with a recess and a second panel with a recess and a pair of U-bars.

FIG. 26B is a horizontal cross-section along line 26B-26B of the panels of FIG. 26A.

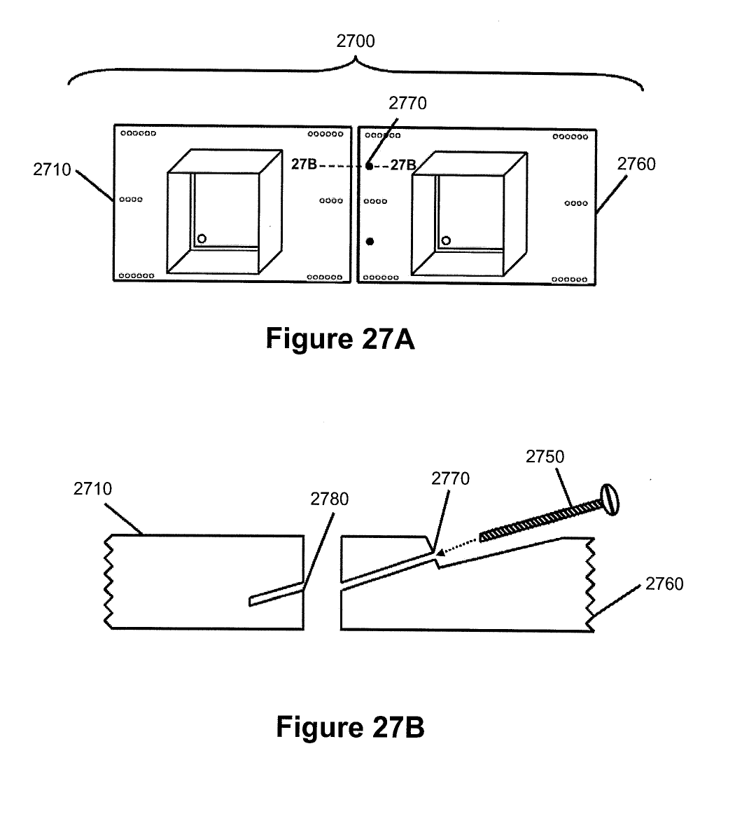

FIG. 27A is a rear plan view of a first panel with an angled screw hole and a second panel with a pocket hole.

FIG. 27B is a horizontal cross-section along line 27B-27B of the panels of FIG. 27A and a screw that fits in the pocket hole and the screw hole.

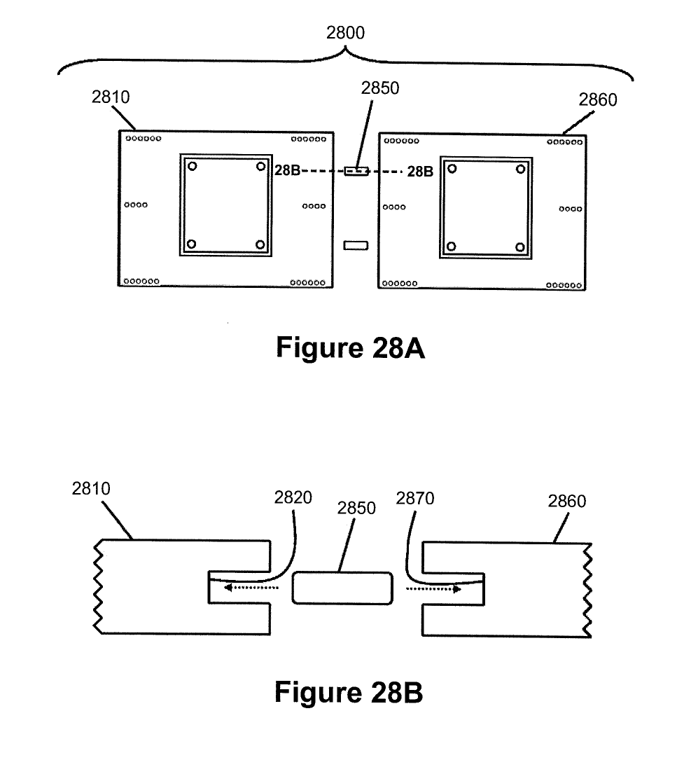

FIG. 28A is a front plan view of a first panel with a pair of recesses, a second panel with a recess and a protruding tab, and a peg.

FIG. 28B is a horizontal cross-section along line 28B-28B of the panels of FIG. 28A.

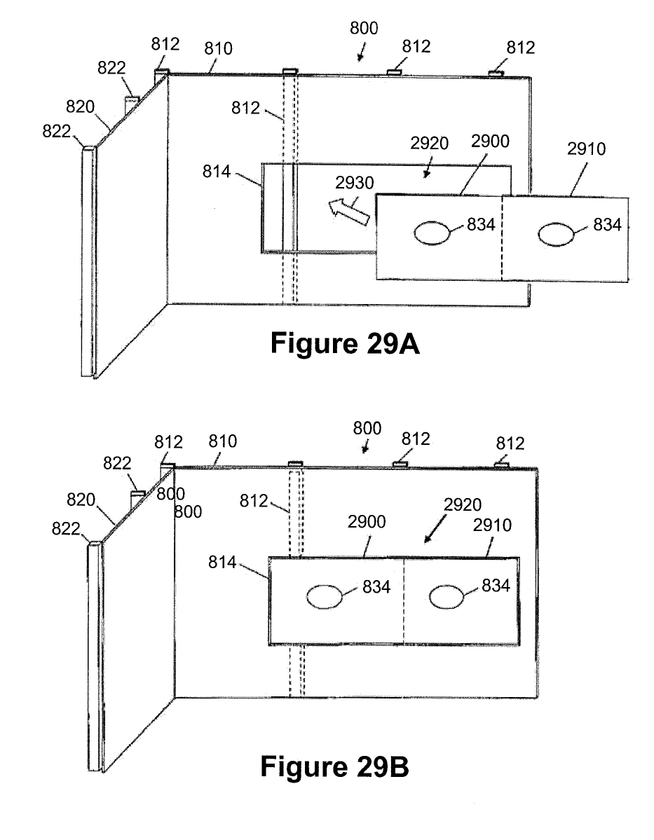

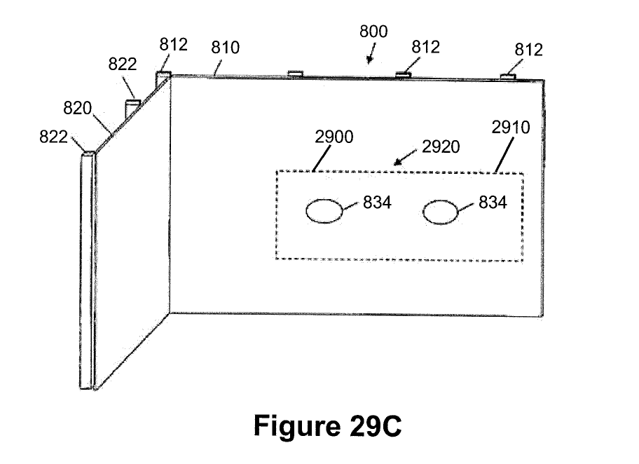

FIG. 29A is a perspective view of two structural components in a building (e.g. walls or wall and ceiling), in which an opening has been cut to receive a multiple panel assemblies.

FIG. 29B is a perspective view of the two structural components of FIG. 29A, in which the panel assembly has been placed within the opening.

FIG. 29C is a perspective view of the two structural components of FIG. 29B, in which the approximated edges of the panel assembly and the wall have been finished to provide a superficially continuous junction.

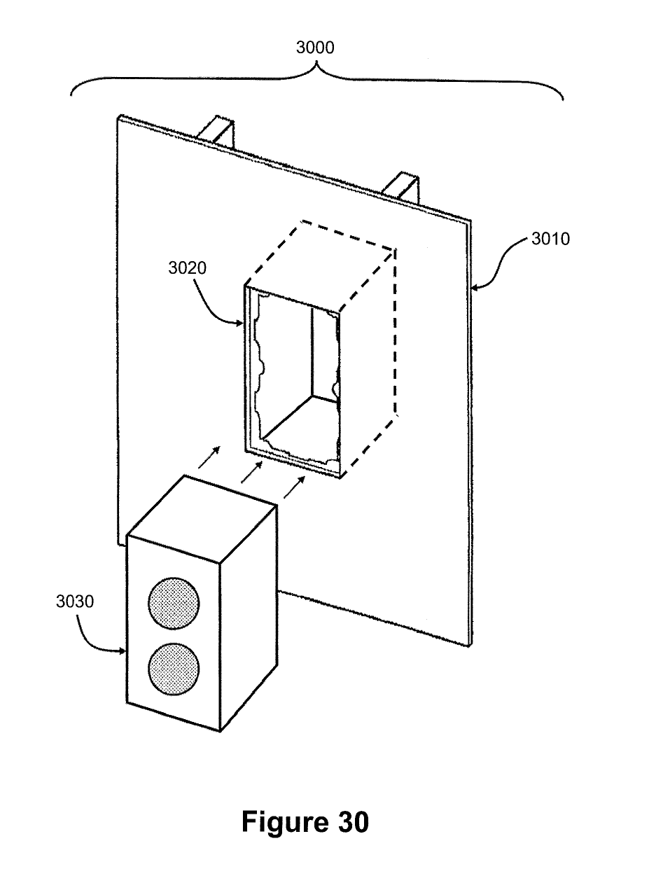

FIG. 30 is a front perspective view of a component and a matching receiver in a wallboard.

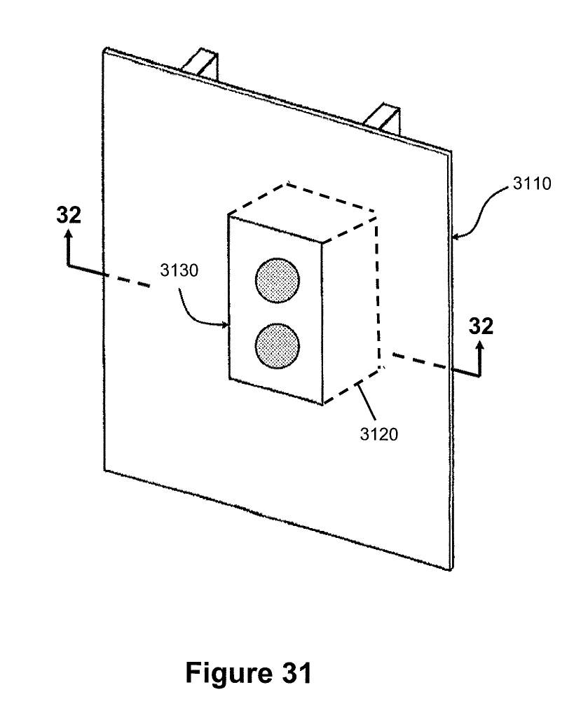

FIG. 31 is a front perspective view of the component mounted in the matching receiver of FIG. 30.

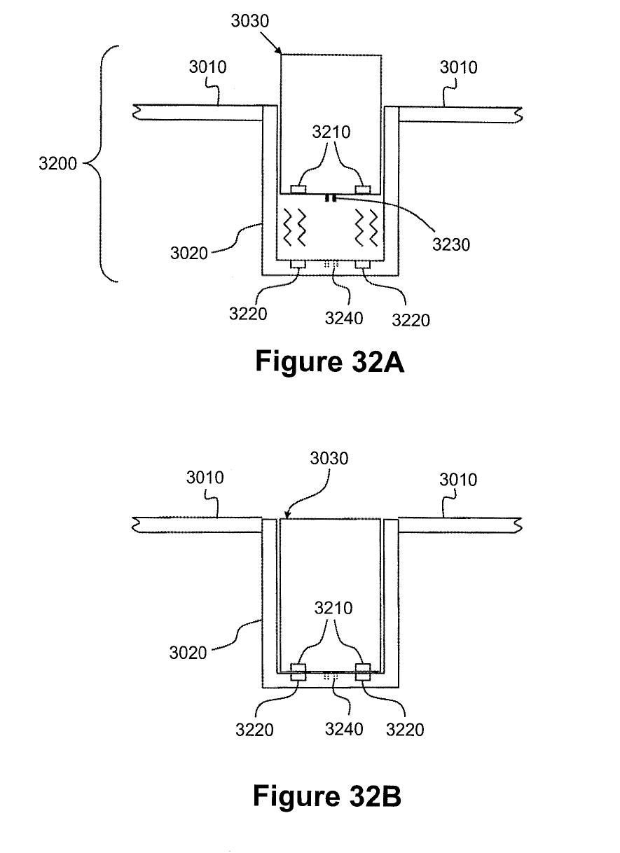

FIGS. 32A-32B are simplified horizontal cross-sections of the component and receiver of FIG. 31, taken along line 32-32.

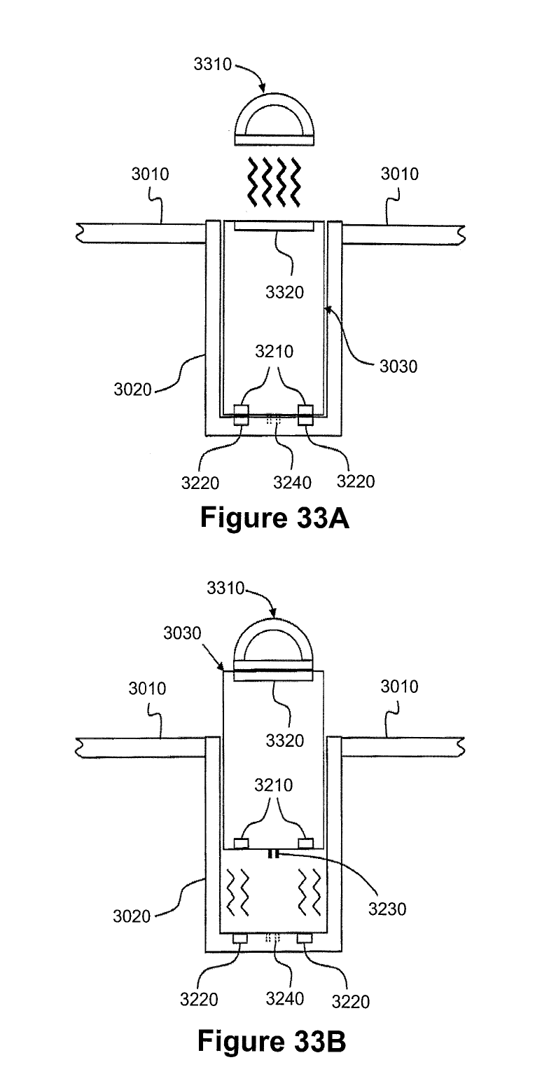

FIGS. 33A-33B are horizontal cross sections of a component that is pulled out of a receiver by applying a magnetic gripper to the front of the component.

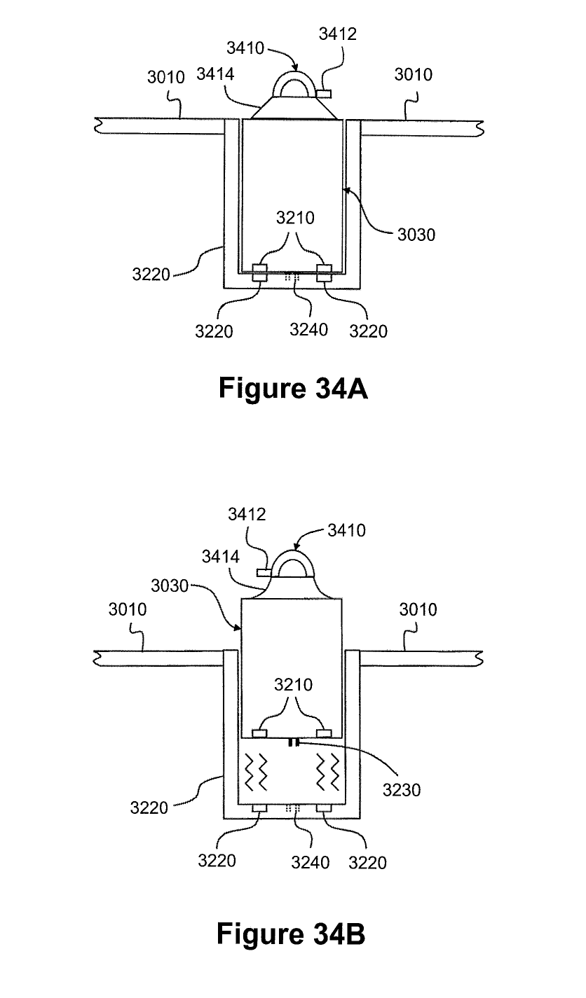

FIGS. 34A-34B are horizontal cross sections of a component that is pulled out of a receiver by applying a vacuum gripper to the front of the component.

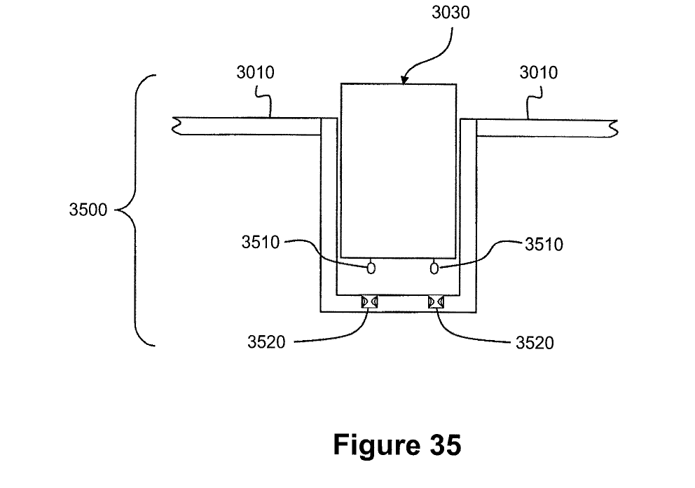

FIG. 35 is a horizontal cross section of a component and receiver that lock using matching indents and detents.

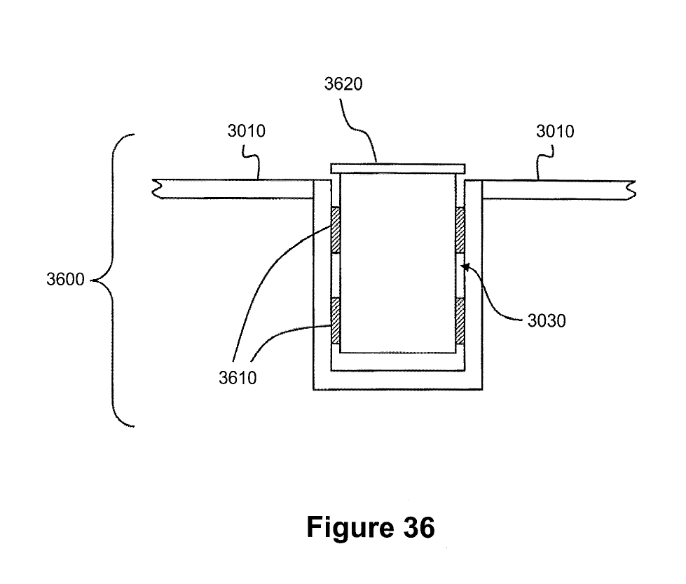

FIG. 36 is a horizontal cross section of a component and receiver that lock using compressible material lining the receiver.

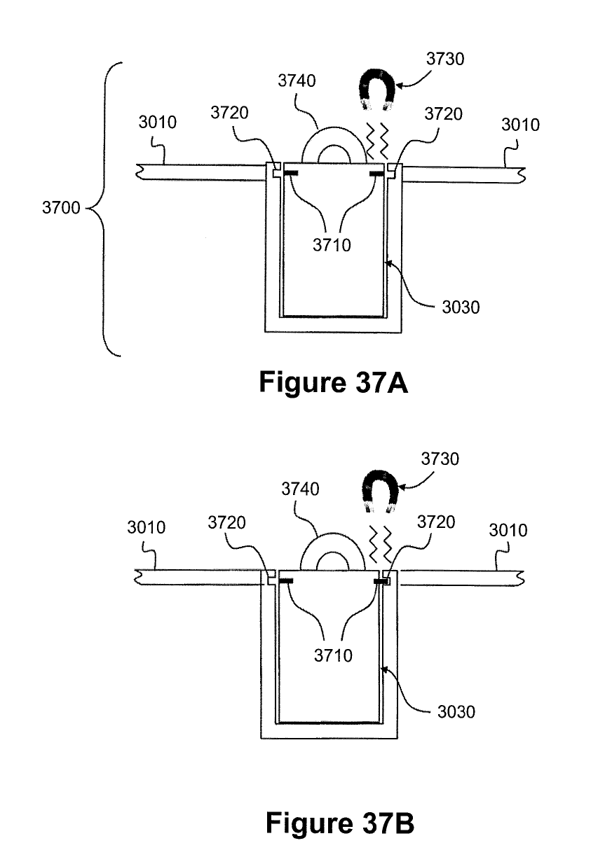

FIGS. 37A-37B are horizontal cross sections of a component and receiver that lock using matching sliding bolts and recesses.

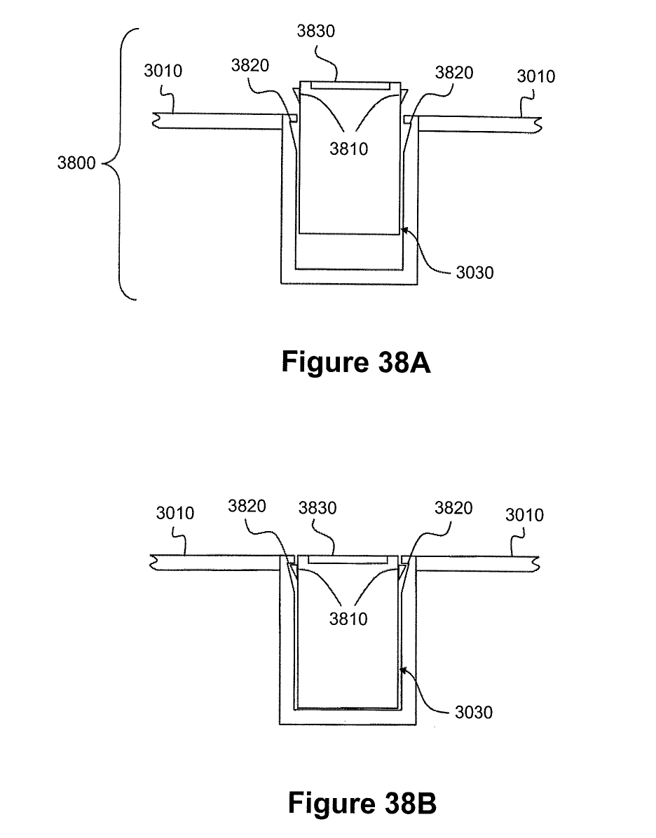

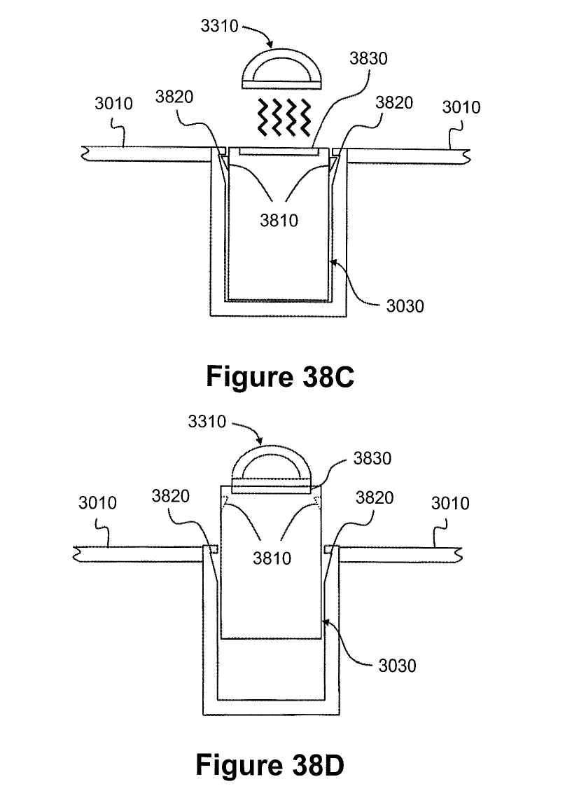

FIGS. 38A-38D are horizontal cross sections of a component and receiver that lock using matching pivoting latches and protrusions.

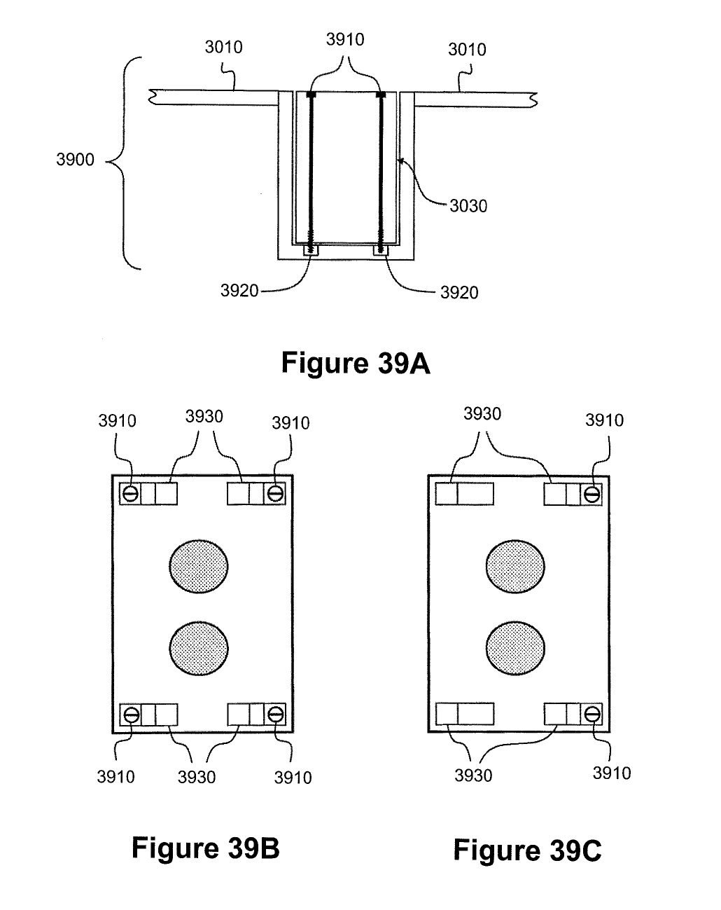

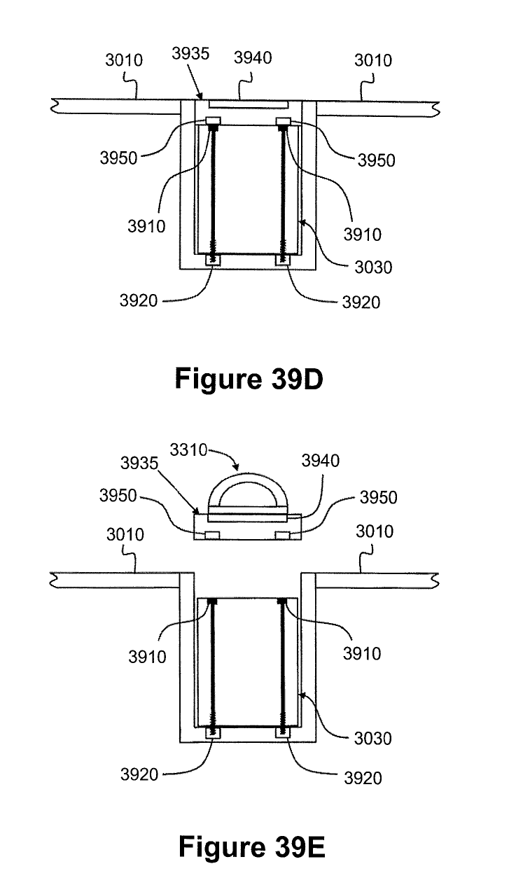

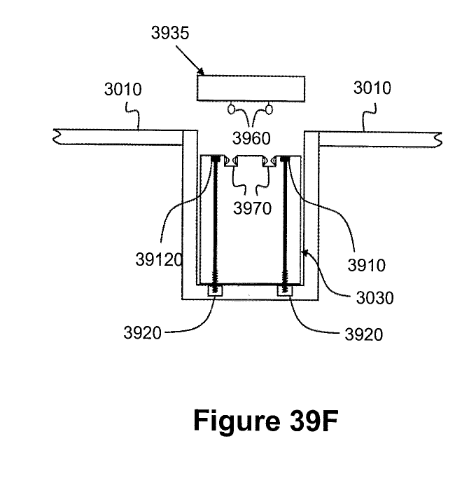

FIG. 39A is a horizontal cross section of a component and receiver that lock using matching threaded bolts and threaded holes.

FIGS. 39B-39C are front plan views of the component of FIG. 39A.

FIGS. 39D-39F are horizontal cross section views of a shortened component and receiver of FIG. 39A, with a magnetic faceplate attached.

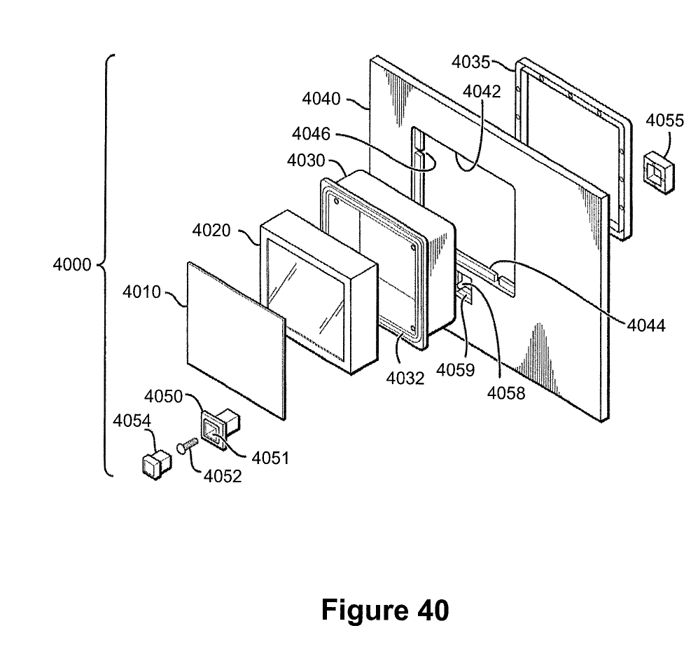

FIG. 40 is an exploded view of a panel, receiver, component, component cover, and logo according to one embodiment.

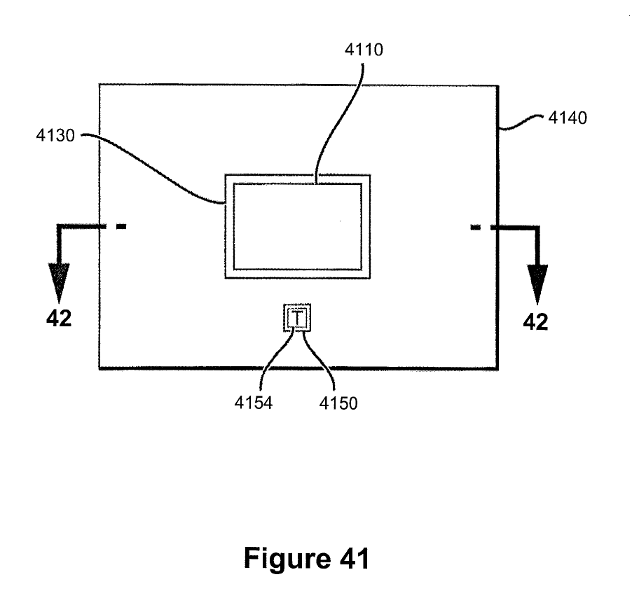

FIG. 41 is a front view of the panel, receiver, component, and component cover of FIG. 40 coupled together.

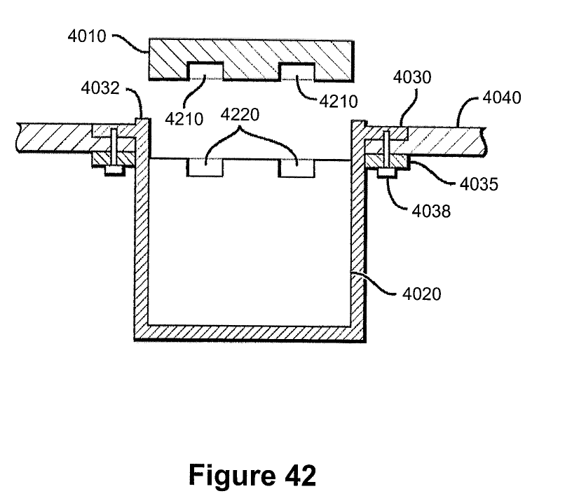

FIG. 42 is a simplified horizontal cross-section of the panel, receiver, component, and component cover of FIG. 41, taken along line 42-42.

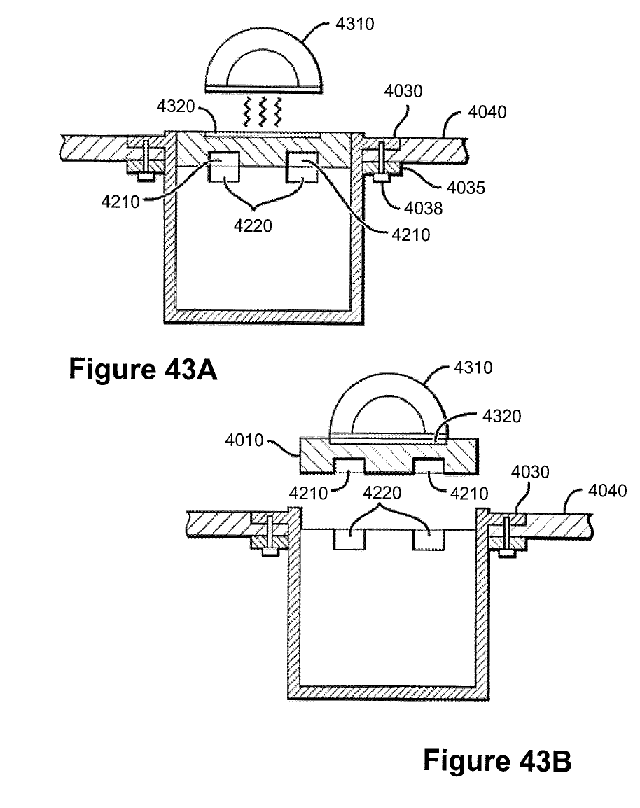

FIGS. 43A-43B show simplified horizontal cross-sections of the panel, receiver, and component of FIG. 42 with a different component cover that is removable using a magnet gripper.

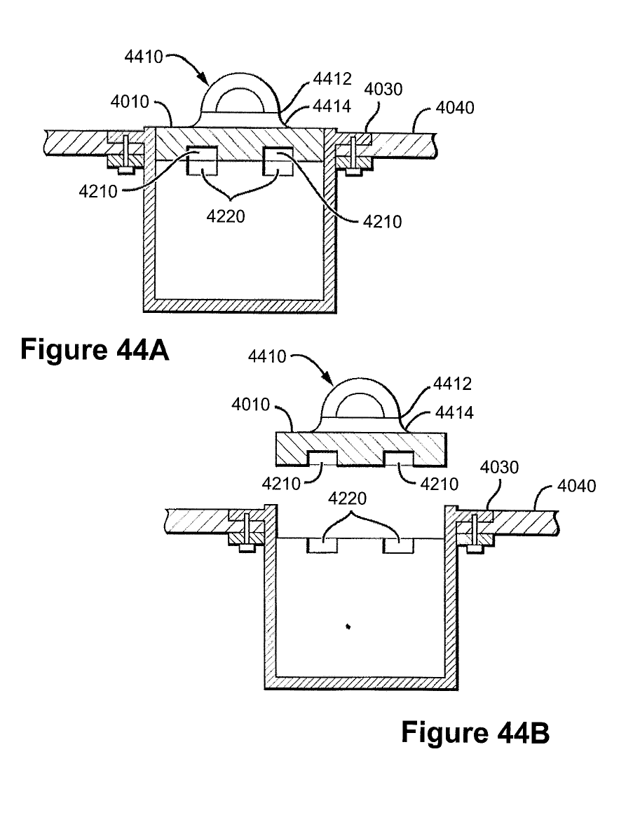

FIGS. 44A-44B show the component cover of FIG. 42 being removed using a vacuum gripper.

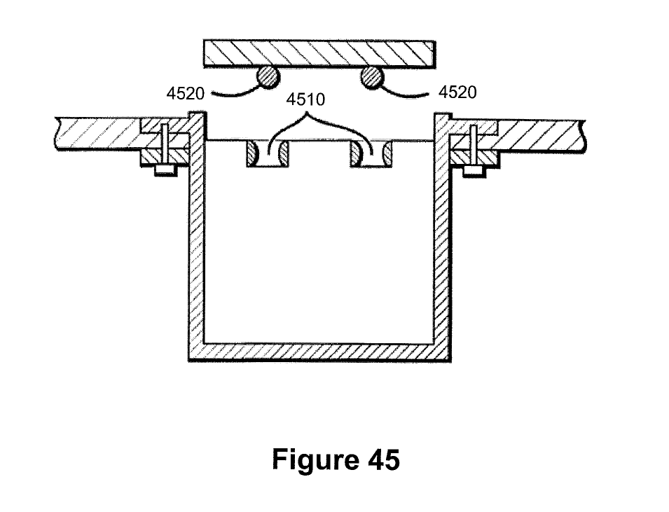

FIG. 45 is a simplified horizontal cross-section of the panel, receiver, and component of FIG. 41, taken along line 42-42, with a different component cover using indents and detents.

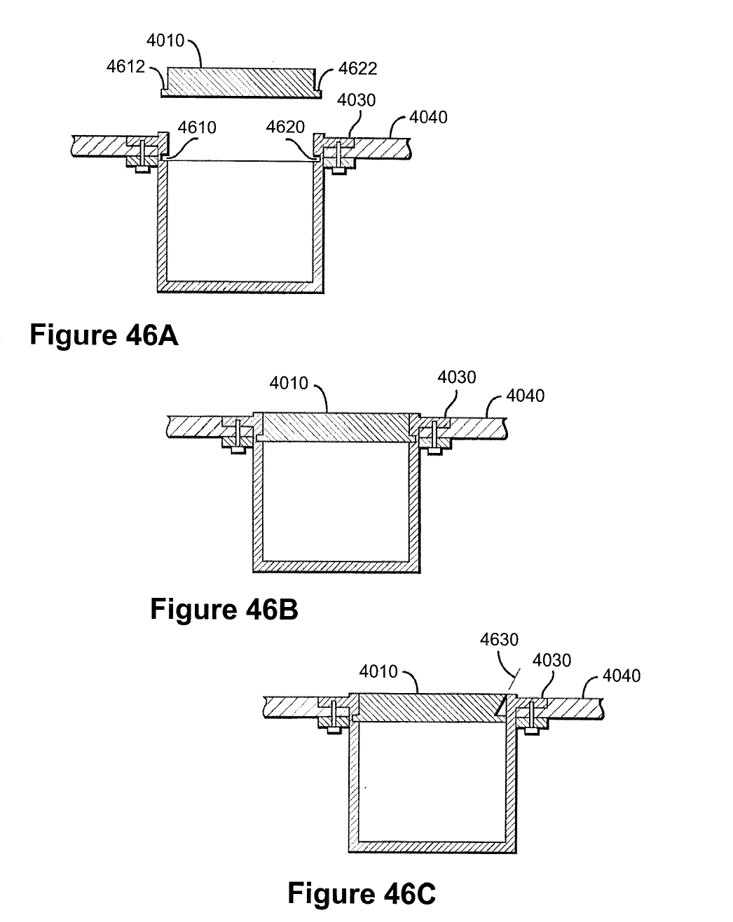

FIGS. 46A-46C show simplified horizontal cross-sections of the panel, receiver, and component of FIG. 41, taken along line 42-42, with yet another component cover using indents and detents.

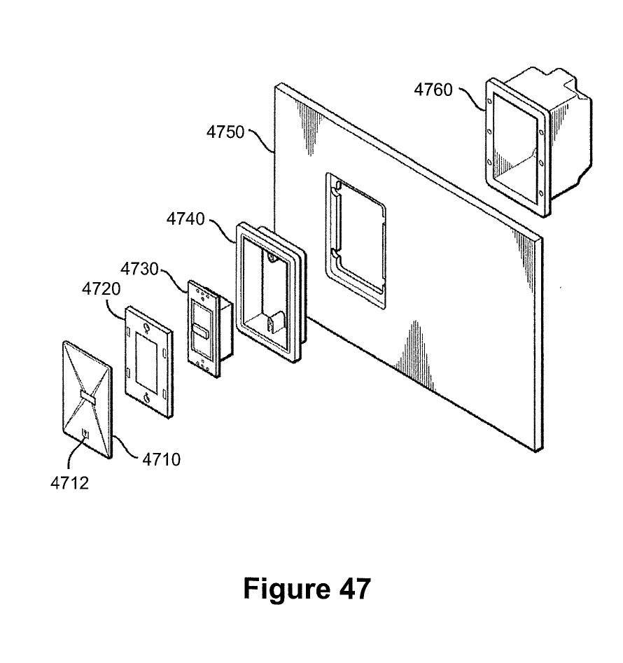

FIG. 47 is an exploded view of a panel, receiver, light switch, and component cover according to another embodiment.

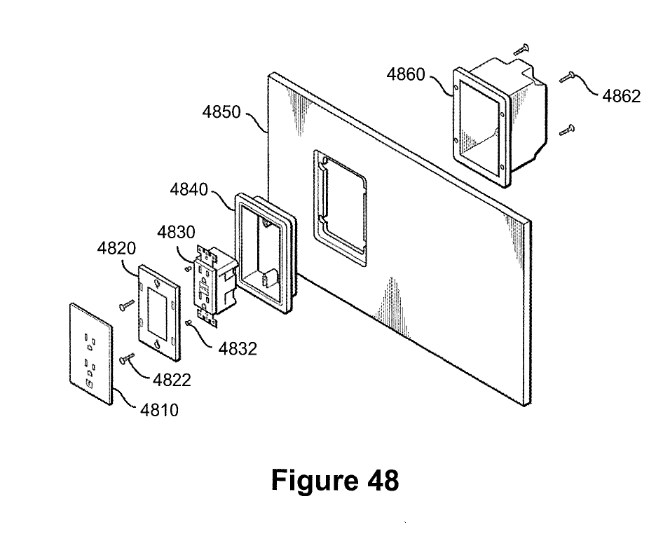

FIG. 48 is an exploded view of a panel, receiver, power outlet, and component cover according to another embodiment.

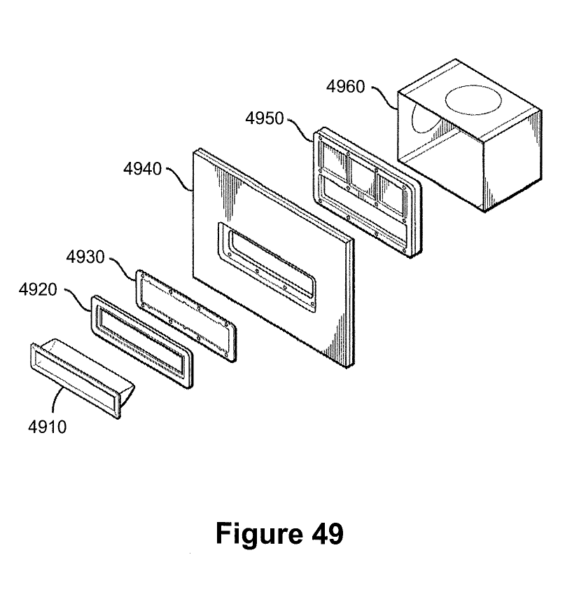

FIG. 49 is an exploded view of a panel, receiver, HVAC unit, and component cover according to another embodiment.

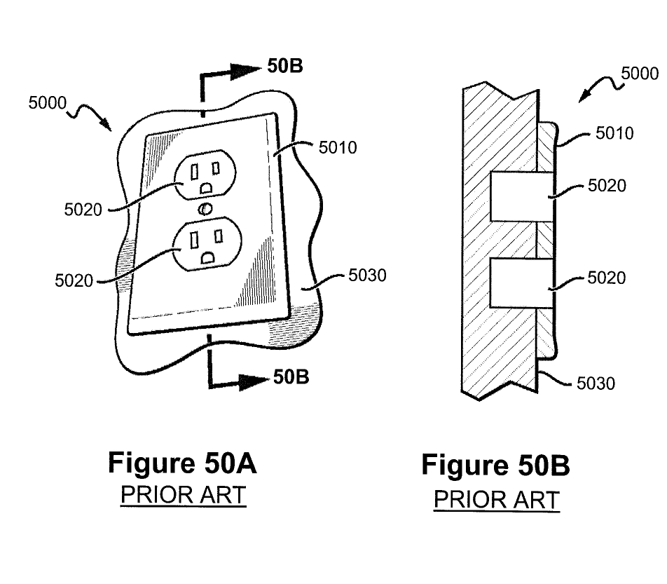

FIG. 50A is a front perspective view of a prior art power outlet.

FIG. 50B is a simplified vertical cross-section of the power outlet of FIG. 50A, taken along line 50B-50B.

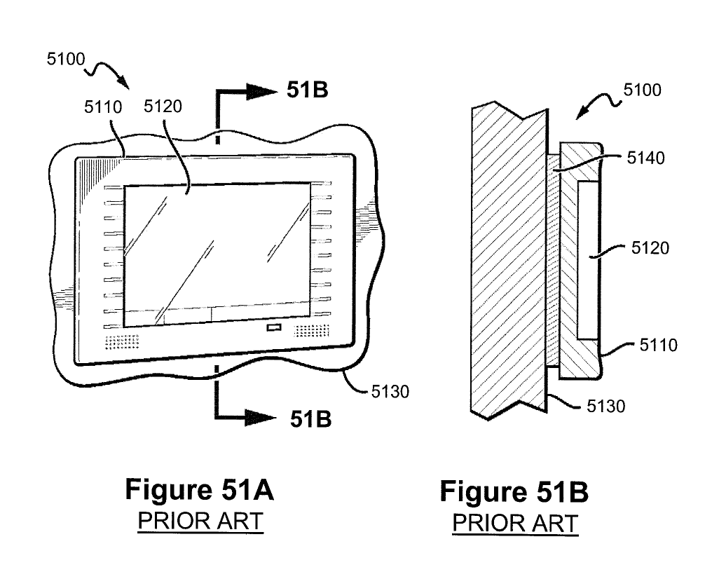

FIG. 51A is a front perspective view of a prior art touch screen.

FIG. 51B is a simplified vertical cross-section of the touch screen of FIG. 51A, taken along line 51B-51B.

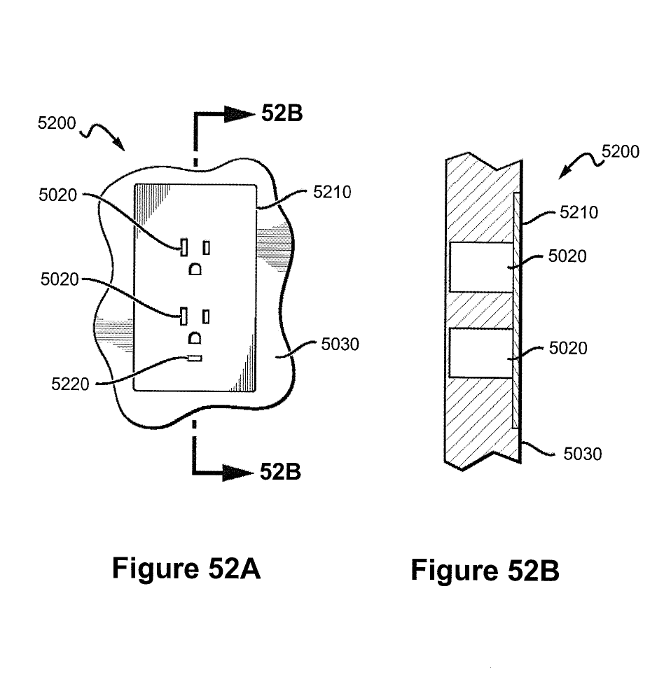

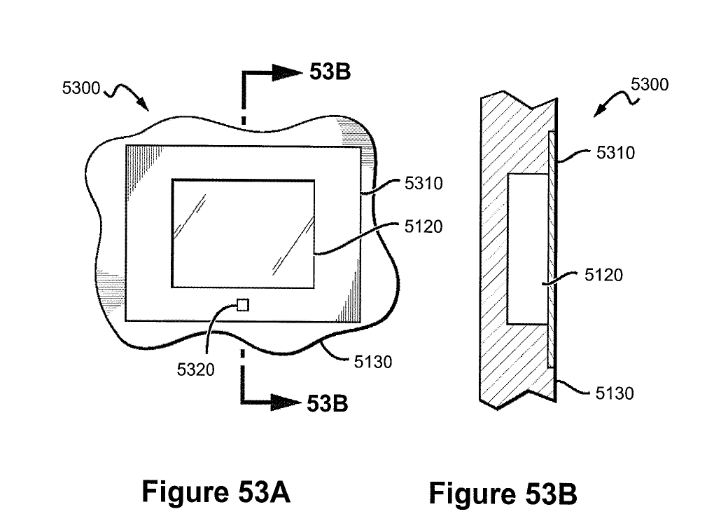

FIG. 52A is a front perspective view of the power outlet of FIG. 50A, where the face plate has been modified or replaced to have a common familial appearance with touch screen of FIG. 53A.

FIG. 52B is a simplified vertical cross-section of the power outlet of FIG. 52A, taken along line 52B-52B.

FIG. 53A is a front perspective view of the touch screen of FIG. 51A, where the face plate has been modified or replaced to have a common familial appearance with the power outlet of FIG. 52A.

FIG. 53B is a simplified vertical cross-section of the touch screen of FIG. 53A, taken along line 53B-53B.

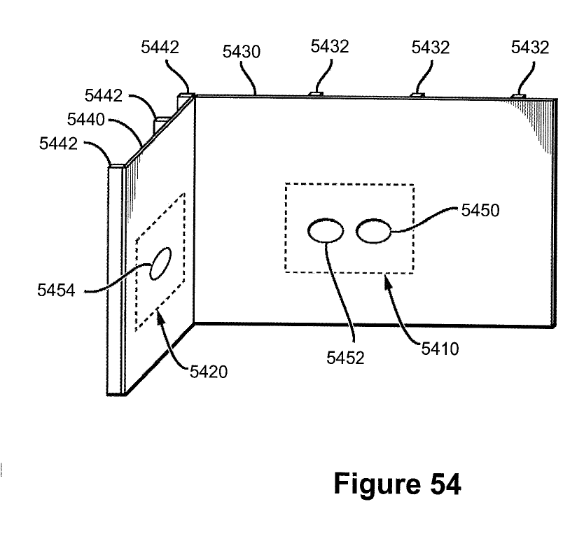

FIG. 54 is a perspective view of the two structural components of FIG. 8C, in which the second wall has a second panel assembly with an installed component that has a common familial appearance with the components installed in the first wall.

### DETAILED DESCRIPTION

In FIG. 2 a panel assembly 100 generally includes a panel 110 with an opening 120, and a receiver 140 disposed in the opening 120, and attachment wings 170A-170D. It should be appreciated that a speaker is used in these figures as an example of a wall mounted component. The same or analogous principles disclosed herein apply to plasma screens, in-wall art panels, in-wall cabinets or display areas, recessed lighting, smoke detectors, windows, and so forth.

Panel 110 is a piece of gypsum board, wood, plastic, or other material (or combination of materials) sufficiently strong to support a speaker or other desired component between two studs of a wall, or joists in a ceiling, or other supports. Where plywood is used as the panel material, for example, the panel might be as thin as ¼ inches (0.635 centimeter), but would more preferably measure at least ½ inches (1.27 centimeters) or ⅜ inches (0.9525 centimeter). Preferred materials include wallboard, Medium Density Fiberboard (MDF), High Density Fiberboard (MDF), Acrylonitrile Butadiene Styrene (ABS), and other materials that closely match various characteristics of drywall. Multiple materials could be used, for example mixed in with one another, alternating, layered on top of one another, or a combination. Preferably, the material has equal moisture absorption and coefficient of thermal expansion as the surrounding wallboard, while having greater durability and strength for attaching heavy components directly to the panel. For example QuietRock® 525 could be a paneling material used where the wallboard comprises drywall. It is preferable for the panel 110, or at least the lateral wings 170A, 170C, to have a width at least six or twelve inches greater than the spacing between studs. The extra width allows the installer considerably greater flexibility in positioning the panel on the wall.

Panel 110 is typically about twenty inches. (about 50 cm) to twenty-four inches (about 60 cm) wide, but other contemplated panels could have any other suitable dimensions, even for example, up to the size to replace an entire sheet of wallboard. Narrower panels are also contemplated, although they would likely not have a sufficient width to extend between wall studs or ceiling joists. Suitable panels would usually have a width of at least six inches (15.24 cm) or twelve in (30.48 cm) greater than the spacing between studs, which allows the installer considerably greater flexibility in positioning the panel on the wall. While panel 110 is shown as a substantially planar apparatus, panel 110 could be concave, convex, or any other shape to either match the shape of the wallboard, or to introduce a non-planar surface to the wallboard.

In ordinary parlance, a wallboard is a building board made for surfacing rather than for insulating ceilings and walls. Wallboards are often made into large rigid sheets that are fastened to the frame of a building to provide a surface finish. However, as used herein, the term “wallboard” should be construed broadly to mean any sort of mechanical barrier for surfacing ceilings or walls, including doors. Wallboards could be made of any suitable material, including for example plywood, plaster, wood, wood pulp, or gypsum. As used herein, the term “wallboard” excludes floors.

Stud attachment designations 112 have a diameter of 0.375 in (9.525 mm), and are approximately ¼ in (6.35 mm) deep, but could be shaped and configured in other suitable ways. The centers of stud attachment designations 112 are spaced approximately 1 inch (approximately 2.54 centimeters) from each other. As used herein, a “stud attachment designation” could be any suitable visual or tactile marker (for example, a hole, an indent, or an ink mark) that shows optimal locations where attachment mechanisms could be fastened. Here, the stud attachment designation is a concave hole primer deepest in the center that helps an installer drill a screw or hammer a nail in a designated place without slipping. The diameter of the hole primer is preferably larger than the diameter of the screw head or nail head used so as to prevent the head of the screw or nail from leaving an unsightly bump on the surface of the wallboard after spackling. Other suitable receivers are contemplated, for example visual marks or pre-drilled and threaded screw holes.

The opening 120 could also be any suitable shape and size. Preferred openings are rectangular to accommodate common rectangular components, for example light switches, wall outlets, speaker volume controls, and home security systems. However, the openings could also be oval or circular or any other desired shape. The area of the opening is generally dependent on the size of the component, and could range up to 80 in² (about 520 cm²) or larger. Especially preferred openings have an area of at least 20 in² (about 130 cm²), 40 in² (about 260 cm²), 60 in² (about 390 cm²), and even 80 in² (about 520 cm²). Nevertheless, for stability, it is contemplated that the panel would have openings with a length that is no more than half or one third the length of the panel.

Any opening could be positioned in any suitable arrangement relative to the panel 110, and indeed FIG. 2 shows an embodiment where the opening 120 is laterally off center with respect to the panel. Openings could be cut at a job site or elsewhere by an installer, but are more conveniently precut (or molded to include the opening) at the manufacturer. It is possible for a panel to have punch-out openings or perhaps cutout lines to facilitate selection of the position of the opening at the job site, but those options are currently disfavored relative to a manufactured pre-cut or molded opening and a relatively large panel.

The top, bottom, and side wings 170A-170D, respectively, preferably extend from the corresponding edges of the panel 110 by at least about one inch, which is deemed to be sufficient space to conveniently drive a nail or screw into a stud. It is also contemplated, however, that at least one of the wings 170A-170D could extend much longer, perhaps 24 to 30 inches or more. Such long wings could accommodate odd installations where the studs are spread apart at a greater distance from each other than normal. Wings 170A-170D are preferably made of a metal mesh, but could include of any suitable material or materials so long as the material(s) provide(s) sufficient shear strength to support the panel 110 and speaker 16. Metal mesh is also desirable because the wings are advantageously relatively thin, so as not to push out the overlying wallboard, and metals could provide considerable strength with thickness of less than 100 mm. It should also be appreciated that although wings 170A-170D are described herein by separate numerals, they may well be one continuous piece of material.

Receiver 140 is preferably sized and dimensioned to fit snugly into the opening 120, but in any event is screwed or otherwise securely attached to the panel 110. The secure attachment is important since in at least some embodiments, the speaker housing will be attached to the receiver 140 rather than being attached directly to the panel 110. Receiver 140 is preferably molded from polyethylene or other sufficiently strong and durable thermoset plastic, and as shown in greater detail in FIG. 3 receiver 140 includes holes 142 for screws (not shown), a recess 144 into which a speaker could be removably secured via a holding mechanism, and a rim 140A, and optional magnets 146 or an optional press fit (not shown). While the receivers and openings are generally shaped and sized to fit particular electronic devices, for example a rectangle for a light switch or a circle for a ceiling light, the universal receivers may be used that could accommodate a variety of electronic devices. To fit the component to a universal receiver, the component could consist of an outer casing that fits around the electronic device and couples to the universal receiver.

FIG. 4 shows a component 16A and a component cover 18. Component 16A should be interpreted as generically representing all practical wall mounted components, including for example speakers, plasma screens, in wall art panels, in-wall cabinets, windows, wall outlets, security systems, fuse boxes, light switches, lighting, sprinkler systems, smoke detectors, and so forth. The various wires for power and signal are not show in the figures, but should be assumed, and could be those conventionally contemplated in the art. Component cover 18 could be any suitable speaker grille, but is preferably a metallic mesh grille that press-fits into the opening 120. Additionally or alternatively, the receiver could include a ferrous material that is attracted to magnets 146 in receiver 140.

As seen in FIG. 5 the rim 140A is sized and dimensioned to extend outwardly from the panel 110 by a very small distance 150, which provides a lip that could readily be used as a stop against which to spread spackle or “mud”. Preferred such distances 150 are less than ⅛ inch, and preferably about 1/16 inch, or in metric terms about 1-3 mm. Preferably, the panel has a thickness of at least ¼ inch (0.635 centimeter). The distance 150 of rim 140A above the panel 110 is thus very different from the distance 15 of rim 14A above the panel 10 in FIG. 1B. In the prior art configuration in FIG. 1B, the rim 14A extends by more than the combined thickness of the panel 10 and the wallboard 30. Also shown in FIG. 5 is an attachment member 148 that helps secure receiver 140 to panel 110.

It should be appreciated that the rim 140A could be separable from the panel. Thus, for example, the rim could be a separately molded piece of plastic, metal or composite that is installed into the opening by the installer, or at a factory.

In FIG. 6A the panel 110 is affixed to two studs 210A, 210B in a wallboard, and screws 215 are inserted through one of the wings 170A and the panel 110. Of course, the positioning and orientation of the panel could be varied in any suitable manner with respect to the studs, 210A, 210B, including moving the panel 110 higher or lower, left or right, or even tilting the panel clockwise or counterclockwise. Similarly, the studs should be interpreted herein as emblematic of any support structures of a wallboard, whether or not such structures are technically considered to be studs. In addition, a greater or lesser number of screws could be used, or inserted in some other arrangement than that shown to provide greater or lesser support. The screws could also be replaced or supplemented by some other attachment means such as adhesive. In preparation for spackling, a spackle shield could covers a opening 190.

Those skilled in the art will appreciate that the combination of panel and receiver could be provided in several different ways. The panel and receiver could, for example, be joined together at a job site, and indeed the panel could even be “manufactured” at the job site by cutting or punching out the opening. More preferably, however, the panel and receiver are provided as an item of manufacture to the installer by a supplier or manufacturer. The rim of the panel could be pre-installed to the panel. Thus, in various embodiments a kit could contain one or more of a panel, a receiver (or at least a rim around the edges of an opening in the panel), a speaker housing, a spackle shield, and installation screws. The installer would then provide whatever labor is appropriate for the installation, including optionally installing the receiver and/or rim, optionally installing the spackle shield, and optionally mounting the speaker into the speaker housing to the back side of the panel. It is also contemplated that the speaker could be pre-installed into the panel before installation. Alternatively the combination of the panel and receiver could be mounted before installing a rim on the opening.

In FIG. 6B wallboard 220 or other wallboard has been installed on all four sides around the panel 110, and coupled to the wings using screws 215. Where wings are present, as in the embodiment depicted, the wallboard 220 overlays the wings, but the wings are sufficiently thin so that the wallboard is not noticeable raised. Those skilled in the art will appreciate that although FIG. 6B shows the wallboard 220 surrounding the panel 110 as a single piece, it is entirely possible that the wallboard could comprise multiple pieces (not shown). It is also contemplated that installation of the wallboard 220 might be delegated to a drywaller or other tradesman distinct from the panel installer. Nevertheless, the process of installing the panel on one or more wallboard supports is deemed to include the step of positioning the panel so that it could be approximated in an end-to-end fashion by a piece of a wall or other wallboard section.

In FIG. 6C mesh tape 230 is applied along the juxtapositions or other approximations between edges of the panel 110 and edges of the wallboard 220. Here again, this step is usually delegated to a professional drywaller, but should be interpreted as being accomplished by the installer of the panel, regardless of which person actually does the work.

In FIG. 6D the mesh tape is covered by a spackling compound, and ready for painting, wallpapering, or other surface coating. Preferably, the spackling compound is smoothed over the entire front surface of the panel to the spackle rim (not shown) about opening 190. As used herein, the terms “spackle” and “spackling” should be interpreted as broadly as possible, to include for example plaster and plastering of any type. The objective is to provide a smoothed out surface that completely or substantially hides the joints between edges of the panel and edges of the wallboard.

In FIG. 6E, the spackle shield is removed from openings 120, and a component can be installed in the new uniform wallboard 240.

In FIG. 7 a panel 300 has two speaker openings 320A and 320B. These openings are each preferably at least 40 inch² in area, but could be any sizes or shapes, and could have any physically orientation and positioning with respect to each other. The openings 320A, 320B have receivers 340A, 340B, respectively, the panel 300 has wings 370A-370D, all in accordance with the teaching herein.

In FIG. 8A an installation 800 generally includes structural component 810, 820, a space 814 on structural component 810, and a panel assembly 830 that will be installed into the space 814, as shown by arrow 840.

As used herein, the term “assembly” means an object that has multiple components or functional portions. Thus, the term comprises: (a) multiple pieces that are coupled together in some manner, either temporarily or permanently; and also (b) a single molded object with multiple functional components. By way of example, panel assembly 892 in FIG. 11 is a panel assembly molded as a single piece.

In typical installations, the structural component 810, 820 would be adjacent vertical wallboards, or a vertical wallboard and a ceiling, and FIG. 8A should be interpreted to include all such embodiments. Thus, for example, where structural component 810, 820 are interpreted to be vertical wallboards, members 812, 822 should be interpreted as studs. Where structural component 810 is interpreted as a ceiling, members 812 should be interpreted as joists, and members 822 should be interpreted as horizontal struts. Although the portions of the structural components 810, 820 are depicted in the figure as substantially flat, those skilled in the art will appreciate that the structures could be curved, or have curved portions. In addition, those skilled in the art will appreciate that structural component 810 could exist independently of structural component 820.

Structural component 810, 820 would typically comprise wallboard, which term is used herein generically to include all manner of wallboard, fiberboard, gypsum board, GWB, plasterboard, SHEETROCK® and Gyproc®, and so forth. Additionally or alternatively, structural components 810, 820 could comprise other materials, including for example polymers, masonry, ceramics, and acoustic ceiling tile materials or other composites. structural component 810, 820 could have any suitable dimensions, from only a few square feet or less, to hundreds of square feet or more. Structural components 810, 820 will usually, however, have relatively small thicknesses of between ¼ inch (0.635 centimeter) and 1 inch (2.54 centimeters) thickness. Unless a contrary intent is apparent from the context, all ranges recited herein are inclusive of their endpoints, and open-ended ranges should be interpreted to include only commercially practical values.

Panel assembly 830 could be produced at a job site, for example, by cutting a hole out of a piece of wallboard. The piece being used in such instances could be cut out from an existing vertical wallboard or ceiling, and or could be completely new to the job site. Either of those methods could work adequately for wallboard, acoustic ceiling tile and other materials that are fairly easy to cut, but for difficult to cut materials, including for example polymers, masonry, and ceramics, the panel assembly could be most conveniently produced in a factory where the panel is dried or cured around a form (see FIG. 11) to define the opening.

As discussed above with respect to FIGS. 2-7, the opening 834 of FIG. 8A could be any suitable size, shape, or number. As currently contemplated, it is desirable that the total front facing area consumed by the opening or openings be relatively small with respect to that of the panel 832. That ratio is preferably at least 3, more preferably at least five. Viewed from another perspective, it is preferred that the panel 832 extend in at least one direction at least 3 inches from the closest edge of the opening 834 for light or other simple switches, electrical outlets and so forth, and at least 5 inches for lights, more complicated switches and other controllers, speakers and so forth. Where the component has a front-facing surface area of at least 25 in², the panel 832 extends in at least one direction at least 12, 18, or even 24 inches from the closest edge of the opening 834.

In FIG. 8B the panel assembly 830 has been placed within the space 814. There will almost always be some gap between the edges of the panel assembly 830 and those of the surrounding structural component 810, ranging in typical installations from zero (where the panel assembly 830 is abutted against the structural component 810), and perhaps ⅛″ to ¼″. Indeed, there will almost always be multiple different gaps around the edge of the panel assembly. Where the workmanship is sloppy, or the project is especially difficult, the gap in some sections could be larger. In addition, it is contemplated that an intermediate member (not shown), as for example a paper, shim, or even a frame could be installed in the gap between the panel assembly 830 and the structural component 810. As long as the edges of the assembly and the structure are somewhat near each other, and the gap could be finished such that an at least superficially continuous junction is established between them, the edges are considered to be approximated.

In FIG. 8C the approximated edges of the panel assembly and the structure have been finished to provide an at least superficially continuous junction. As used herein the term “at least superficially continuous junction” refers to a junction that appears to casual observation to be seamless. By way of example, a good workman-like job in taping and plastering adjacent sections of wallboard board is considered herein to produce an at least superficially continuous junction, especially where subsequent painting or wallboard papering eliminates any seam apparent to casual observation.

In FIG. 9 a rear view of the panel assembly 830 of FIGS. 8A-8C shows a receiver 838 and attachments 836 of the receiver to the panel 832. The receiver 838 in this instance is an open box, but all manner of alternative receivers are also contemplated. For example, receivers could be tubular or have some other shape, and could be completely or partially closed, and could have punch outs such as those found on a typical electrical connection box.

The attachments 836 are shown as four wings, extending from the four sides of the receiver 838, and then glued, nailed, stapled or otherwise affixed to the panel 832. Those skilled in the art will appreciate that still other methods could be used, including forming the panel 832 around the wings. Still further, it is contemplated that wings could be eliminated altogether. In a ¾″ or 1″ thick fiberboard, for example, a collar pressed into the opening, or used as a form around which the fiberboard is made, might have sufficient strength to hold a relatively lightweight component.

FIGS. 10A-10D depict alternative mechanisms for seating various components 861-864 within receivers 838. In FIG. 10A the mechanism comprises magnets 872. In FIG. 10B, the mechanism comprises a long threaded bolt 874A that is turned into a nut 874B. In FIG. 10C the mechanism comprises detents that fit within biasing members 876B. In FIG. 10D the mechanism comprises a compressible polymer or fabric that fits in the gap between the rear portion 864B of the component 864, and the receiver 838. In this particular example, the face plate 864A of the component 864 is larger across than the rear portion 864B.

In FIGS. 10A-10D component 861 is a speaker or other speaker assembly 861A, component 862 is a light or other switch, (showing toggle 862A), component 863 is a light, light fixture or other light assembly, and component 864 is a generic component that should euphemistically be viewed as an electrical outlet, or any other reasonably installable component. Of course, the combinations expressly depicted in the figures are merely examples, and thus it should be appreciated that one could combine any of the components 861-864 with any of the depicted seating mechanisms, or indeed any suitable seating mechanism.

FIGS. 10A-10D also demonstrate that the face of the components are only optionally made completely flush with the face of the panel 832 when they seat with the receiver 838. FIG. 10D, for example, shows a face plate 864A that is recessed from the face of the panel 832. Here, those skilled in the art will appreciate that the recess is exaggerated to assist visualization. In practice, any such recess or extension would likely be less than ⅛^{th} inch. Furthermore, it is contemplated that the components could be easily removed by extraction tools, such as a screwdriver and the like, to provide for simpler change of installation.

FIG. 11 is a perspective view of a panel assembly 890 being formed by pouring a panel material from container 892 into a mold 894. This process brings the poured material right up against the frame portion that defines the opening 896, regardless of any irregularity or other difficulties with the shape of the opening. All manner of panel materials are contemplated, including for example curable plastics, and masonry composites.

FIG. 12A is a front perspective view of a panel assembly 900 having a panel 910 with a spackle shield 922 about the opening 920. The panel 910 is preferably shipped with a paper covering 912 around the outer edges for protection. The covering 912 could either be removed or left in place when finishing the panel 910 to surrounding wallboard (not shown). The panel 910 could advantageously include instructions, trademark markings, (collectively 914), and so forth.

The spackle shield 922 has a shallow lip (not shown) that extends out from the front side of the panel 910 by about ⅛ inch to 1/16 inch, or in metric terms about 1-2 mm. Those distances are to be reasonable to provide a stop up to which an installer could feather a smooth edge of spackle or “mud”.

As best seen in FIG. 12B, spackle shield 922 also has an attachment plate 924 that is recessed from the front side by about ½″, or in metric terms a little over 1 cm. Of course, other distances could alternatively be used for the recess. In this particular instance, plate 924 has an optional level 926 that could be used by the installer to install the panel assembly 900 so that the plate 924 is level. Optional screws or bolts 928 could be used to tighten the shield 922 against the panel 910.

FIGS. 12C and 12D show the back of panel 910 and shield 922, including: the back side of the level 926; optional protrusions 921 forming part of the logo; the open ends of screws or bolts 928, which are seated in female threaded receivers 929; and additional female threaded receivers 927 to receive bolts or screws (not shown) used to attach a speaker or other device (not shown) against the back of the plate 924. Shield 922 could be glued against the panel 910 using glue 916, and the back side of the junction between the shield 922 and the panel 910 could be covered with tape 918 to improve appearance.

FIGS. 13A and 13B show a panel assembly 1300 with an opening 1310, a spackle rim 1312 disposed about the opening, a spackle shield 1320 disposed within the opening, a gradient 1306, as shown in FIG. 14A, that extends from the spackle rim 1312 to the edge 1302, and stud attachment designations 1304. Panel assembly 1300 is similar in many respects to panel assembly 100, and differs only in the ways described below.

Spackle rim 1312 is disposed about opening 1310 and is sized and dimensioned to extend outwardly from the front surface of the panel. Preferably spackle rim 1312 forms a substantially sharp point at the top edge of the rim so that an installer of the panel does not waste spackle component by brushing spackle component into the opening. Preferably, the thickness of the panel about spackle rim 1312 is uniform, and forms the thickest part of panel assembly 1300, forming a “volcano” shape. While spackle rim 1312 is shown as a rectangular perimeter of opening 1310, spackle rim could be any shape or size to accommodate a component.

The thickness of panel assembly 1300 at spackle rim 1312 is about 3 cm and the thickness of panel assembly 1300 at edge 1302 is about 2.5 cm, which forms a gradient 1306 with a height of about 5 mm from spackle rim 1312 to edge 1302. Preferably, the gradient 1306 has a greatest height of less than 10 mm, less than 8 mm, less than 5 mm, less than 3 mm, or less than 2 mm. While gradient 1306 is a curved gradient that extends along the entire surface of the panel, gradient 1306 could be a linear gradient that extends along the entire surface of the panel, as shown in FIG. 15A, or could extend from the rim a short distance before flattening out, as shown in FIG. 15B. In FIG. 15C, gradient 1446 only extends from spackle rim 1452 to substantially flat section 1448. As used herein, “substantially flat” means that the deviation from an average elevation across the section is less than 1 mm. As used herein, “flat” means that the deviation from an average elevation across the section is less than 0.5 mm. Preferably, the gradient 1306 extends from spackle rim 1312 by at least 10 mm, at least 20 mm, at least 30 mm, at least 40 mm, or at least 50 mm.

Spackle shield 1320 preferably covers opening 1310 to prevent mud, drywall, or other spackle component from entering the interior of the opening, particularly when a receiver is installed within the opening. Spackle shield 1320 could be removed after spackling by unscrewing screws 1322 from bolts 1324. This is particularly helpful for when an electronic component is pre-installed behind the panel before spackling, as it prevents a substantial amount of foreign particular from adulterating the electronic component.

As shown in FIG. 14B, an installer could spread spackling component 1340 across the surface of panel assembly 1300 up to wallboard 1350 to create a superficially continuous junction. Spackle shield 1320 could have an optional laser leveler 1330 that shines a later light 1332 across the surface of the spackling component 1340 and the panel assembly 1300. The laser light 1332 could easily show an installer where the spackling component 1340 has extended past the front surface of wallboard 1350, so that he knows which sections of spackling component needs to be flattened out. Preferably, laser light 13320 could be rotated about an axis 1344 (shown in FIG. 13B), so that an installer could check the level of spackling component 1340 applied across the entire surface of the panel assembly 1300 and the wallboard 1350 and ensure a truly flush installation.

FIGS. 15A-15C show alternative panel assemblies with gradients. FIG. 15A shows the panel assembly 1300 with a receiver 1500 installed in opening. Receiver 1500 has a separate spackle rim 1502 that extends slightly past the surface of spackle rim 1312. FIG. 15B shows a panel assembly 1520 with a linear gradient 1526 that extends from spackle rim 1532 to panel edge 1522, while FIG. 15C shows a panel assembly 1540 with a gradient 1546 that extends from spackle rim 1552 to substantially flat section 1548.

FIGS. 16A-16B show alternative panel assemblies with an opening on a side of the panel as opposed to in a middle section of the panel. In FIG. 16A, a component panel 1600 has a semi-circular opening 1610 along an edge 1602 of the panel, and in FIG. 16B, a panel 1620 assembly has a triangular opening 1630 along an edge 1622 of the panel. Panels with an opening on an edge of the panel could be used to mount a component along a corner of a wallboard. Such a panel would need to abut or closely abut a matching panel on the adjacent corner of the wallboard to fit a receiver that would receive the wall component.

In FIG. 17 a panel assembly 1700 generally includes a panel 1710 with openings 1720, 1730, and 1740. Each opening 1720, 1730, and 1740, has a receiver 1750, 1760, and 1770, and a spackle shield 1755, 1765, and 1775, respectively. It should be appreciated that while each receiver is sized and dimensioned to hold a specific component, the receivers could be identical to one another to create a “universal receiver system” that can hold multiple components of various sizes.

The openings 1720, 1730, and 1740 are shown to be identical in height, and are aligned with one another in a row, but it should be appreciated that the openings do not have to have any shared dimensions, and could be positioned in any suitable arrangement relative to the panel 110. Openings with varying height could be aligned along their top or bottom edges, aligned along a centerline, or could be arranged in a staircase fashion with a top edge aligned to a bottom edge. Openings could be cut at a job site or elsewhere by an installer, but are more conveniently precut (or molded to include the opening) at the manufacturer. It is possible for a panel to have punch out openings or perhaps cutout lines to facilitate selection of the position of the opening at the job site, but those options are currently disfavored relative to a manufactured pre-cut or molded opening and a relatively large panel.

As seen in FIGS. 18A and 18B, a receiver backing 1800 with screw holes 1802 could be used to clamp receiver 1770 to panel 1710. In this embodiment, attachment member 1704 fits within recess 1706 on the front of panel 1710 and receiver backing 1800 fits within recess 1808 on the back of panel 1710. Screw 1810 threads through screw holes 1802 and 1812, and finally through nut 1814 to provide a clamping force around panel 1710. Clamping receiver 1770 to panel 1710 provides a secure connection without the need for expensive glues or adhesives.

FIGS. 19A-19E show how the panel 1710 of FIGS. 6A-6E can be configured to have multiple openings. Opening 190 of FIGS. 6A-6E is replaced by openings 1900, 1902, as shown in FIGS. 19A-19E. All the features and inventive concepts of FIGS. 6A-6E can be incorporated into a panel assembly with multiple openings. While panel 1710 in FIGS. 19A-19E only have two openings, it is contemplated that the number of openings can be varied. Likewise, the alignment, size, shape and orientation of openings can be varied.

FIGS. 20A-20B show how the panel assembly 830 installed in space 814 of FIGS. 8A-8C can be modified to have two openings for panel assembly 2030 installed in space 814. Opening 2000, 2002 of FIGS. 20A-20B can be configured to receive components for installation. All the features and inventive concepts of FIGS. 6A-6E can be incorporated into a panel assembly with multiple openings. While panel assembly 830 in FIGS. 20A-20E only has two openings, it is contemplated that the number of openings can be varied. Likewise, the alignment, size, shape and orientation of openings can be varied.

FIG. 21 shows how the features and inventive concepts discussed in FIG. 11 can be equally applied to a panel assembly with multiple openings. In FIG. 21, panel assembly 2190 is formed by pouring a panel material from container 892 into a mold 2194. This process brings the poured material right up against the frame portions that define openings 2100 and 2102, regardless of any irregularity or other difficulties with the shape of the opening.

FIGS. 22A-22C are front plan views of walls and ceilings with components installed in the receivers. FIG. 22A shows components installed in the panel of FIG. 17, with a light switch 2210, a volume control 2212, and a security system 2214, all aligned horizontally in a row. FIG. 22B shows an installation where the components are aligned in a staggered pattern that could be used, for example, long a staircase, with a portrait 2220, a security system 2222, and volume controls 2224, 2226, and 2228. FIG. 22B shows a ceiling installation with a speaker 2230, a sprinkler spigot 2232, and a recessed light 2234. As shown, the present invention can be used to mount multiple flush-mounted components in various configurations with greater accuracy than prior art could provide.

In FIG. 23 a panel assembly 2300 generally includes a panel 2310, with opening 2320 and panel 2360 with opening 2370. It should be appreciated that while each receiver is sized and dimensioned to hold a specific component, the receivers could be identical to one another to create a “universal receiver system” that can hold components of various sizes.

Panel 2310 and panel 2360 are preferably substantially identical to one another in terms of shape, size, dimensions, and material, but can vary from one another without departing from the scope of the previous invention. Where the specification refers to only one panel in a figure, it is to be assumed that the other panel in the figure has the same features, unless otherwise stated.

Panels 2310 and 2360 could be aligned along their top or bottom edges, aligned along a centerline, or could be arranged in a staircase fashion with a top edge aligned to a bottom edge. In FIG. 23, laser light 2340 and an alignment indicator 2390 are used to align panel 2310 with panel 2360 along a centerline marked by laser beam 2342. Alignment indicator 2390 is shown as a line marked along a horizontal centerline of panel 2360, but could be any other suitable alignment indicator, including a series of marks in a row, an edge of panel 2360, or an edge of opening 2370. While the alignment indicator is generally a straight line, the indicator can be a curve or other shape, especially if the opening or receiver is not straight. Laser light 2340 could also fan out a second line (not shown) that runs perpendicular to laser beam 2342 to designate a second axis of alignment. One of ordinary skill in the art would appreciate that a second line could necessitate a second alignment indicator on panel 2360. Additionally, since lasers can fan out lines in multiple directions, a laser level could be used to align panels placed on different wallboards of a room.

FIG. 24 shows an alternative panel assembly 2400 with panel 2410 and panel 2460. Panel 2410 has opening 2420, receiver 2422, and spackle shield 2424. Similarly, panel 2460 has opening 2470, level 2475, and spackle shield 2474. Additionally, panel 2460 has a level 2475 that assists an installer during installation. More importantly, panel 2410 has protrusion 2430 and recess 2440 that interlock with recess 2490 and protrusion 2480 on panel 2460, much like dovetail joints. The interlocking edges of panel 2410 and 2460 not only help mate the two to one another, but also act as an alignment mechanism to help align the position of panel 2410 with respect to panel 2460. Protrusion 2430 and recess 2490 are shaped differently than the other protrusions to ensure that the panels interlock in only one way. While adding one or more such “unique protrusions” is advantageous, ensuring that the panels interlock in only one way is not necessary. Indeed, in some situations it may be beneficial to the installer to use panels that can interlock in multiple ways, so as enable a small variety of alignment positions.

When the edges are interlocked, the top and bottom edges of panel 2460 are in line with the top and bottom edges of panel 2410. It is appreciated that different configurations of interlocking edges can bring the panels into other desirable configurations and orientations relative to one another without departing from the scope of the present invention. Edges that “interlock” with one another can be sized and shaped to interlock directly with one another, or can have recesses that mutually receive a single peg, pin, screw, U-bar, or other similar device, as shown in FIGS. 26-28.

The panels are aligned when the interlocking edges of the panels are approximated to one another. “Approximating” is defined herein to mean bringing the edges near or towards one another so that the junction or gap between the edges is less than 10 mm (0.3937 inch), 5 mm (0.1969 inch), or even 2 mm (0.07874 inch). Preferably, the panels are glued to one another before mounting onto the wallboard. The junction can also be taped and/or covered with a spackling compound to both join the panels and prevent the panels from skewing or misaligning.

Interlocking protrusions and recesses do not have to be formed on the major planes of the panels. For example, in FIGS. 25A and 25B, a panel assembly 2500 has a panel 2510 with a recess 2520 and a panel 2560 with a matching protrusion 2570. As shown more clearly in FIG. 25A, the protrusions and recesses are cut are tongues and grooves instead of dovetails. All other suitable ways of forming interlocking edges are contemplated, including for example using matching snaps, butt joints, and mortise/tendons.

FIGS. 26A and 26B shows another alternative panel assembly 2600 that aligns panels 2610 and 2660 using recesses 2620 and 2670, respectively, located on the backside of the panels. As U-bar 2650 mates with recesses 2620 and 2670, the panels are more accurately aligned. U-bar 2650 is a bar with square-shaped pegs that interlock with recesses on both panels and holds the panels in alignment relative to one another. The pegs and recesses may be any suitable shape, but is preferably non-circular to prevent the pegs from twisting within the recess. Additionally, glue or matching indents/detents could be used to prevent U-bar 2650 from slipping out of recesses 2620 and 2670. While it is appreciated that recesses 2620 and 2660 could also be located on a front of the panels, it is preferred that the recess is on the back of the panel to prevent bulging on the front of the panel. Multiple sets of U-bars and recesses can be used to ensure that the panels do not fall out of alignment.

FIGS. 27A and 27B shows an alternative panel assembly 2700 that aligns panels using screws and screw-holes. An installer can abut the edges of panel 2710 and panel 2760 with one another while threading screw 2750 through pocket hole 2770 in panel 2760 into screw-hole 2780 in panel 2710. Pocket hole 2770 is preferably sized and dimensioned such that when screw 2750 is fully screwed in pocket hole 2770, the head of screw 2750 does not protrude from the back surface of panel 2760. Multiple screws and pocket holes are preferred to help hold panel 2710 in place against panel 2760 and ensure that the panels do not fall out of alignment.

FIGS. 28A and 28B illustrates yet another alternative panel assembly 2800 with panel 2810 and panel 2860, where the panels are aligned with respect to one another using pegs. An installer generally coats a wooden peg 2850 with glue and inserts peg 2850 into opposing recesses 2820 and 2870 in panels 2810 and 2860, respectively. The location of the recesses determines how the panels are oriented with respect to one another.

FIGS. 29A-29C show how the features and inventive concepts of aligning multiple panels can be incorporated into the installation features and concepts of FIGS. 8A-8C. In FIG. 29A, panel assembly 2900 and panel assembly 2910 have been aligned or interconnected using any one of the alignment concepts previously discussed, and are now being installed into space 2920 as a single panel assembly, as shown by arrow 2930. It is also contemplated that panel assembly 2900 and panel assembly 2910 can be aligned or interconnected after being positioned or partially positioned into space 2920. FIG. 29B shows panel assembly 2900 and panel assembly 2910 after alignment and installation. FIG. 29C shows panel assembly 2900 and 2910 after the junction between the two panel assemblies has been finished, such as by taping, spackling, sanding, and painting, to provide an at least superficially continuous junction.

In FIG. 30, a panel assembly 3000 generally includes a wallboard 3010, a receiver 3020, and a component 3030. It should be appreciated that while component 3030 is a speaker, any suitable component mounted to a wall could be used, for example plasma screens, in-wall art panels, in-wall cabinets, windows, wall outlets, security systems, fuse boxes, light switches, lighting, sprinkler systems, smoke detectors, and so forth. While the receiver is generally shaped and sized to fit particular electronic devices, for example a rectangle for a light switch or a circle for a ceiling light, the universal receiver may be used that can accommodate a variety of electronic devices. To fit the component to a universal receiver, the component could consist of an outer casing that fits around the electronic device and couples to the universal receiver.

As shown in FIG. 31, component 3130 can be inserted into receiver 3120 to create a flush-mounted appearance within wallboard 3110. Flush-mounting means to make a surface of the component substantially flush with the surface of the wallboard. Although the portions of the wallboard 3110 depicted in the FIG. 31 is substantially flat, those skilled in the art will appreciate that the structure could be curved, slanted, or have curved/slanted portions in any direction. Preferably, a locking mechanism (not shown) locks component 3130 to receiver 3120 to prevent the component from being removed from the receiver. In an exemplary embodiment, the locking mechanism completely immobilizes component 3130 within receiver 3120 until the locking mechanism is disengaged. The locking mechanism is hidden from view once the component is installed in the receiver so as not to disturb the elegant flush-mounted appearance. Contemplated locking mechanisms are disclosed in FIGS. 32-37, and are discussed in detail below.

In FIGS. 32A and 32B, a magnet locking mechanism 3200 generally comprises magnet attractors 3210 and magnets 3220. Magnets 3220 pull component 3030 into receiver 3020 so that the front portion of component 3030 is flush with the front of wallboard 3010. While magnets 3220 do not have to be particularly strong, magnets 3220 are preferably strong enough to pull component 3030 into the locked position when magnets 3220 are less than 5 inches (12.7 centimeters), 2 inches (5.08 centimeters), or 1 inch (2.54 centimeters) from magnet attractors 3210. It should be appreciated that magnet attractors 3210 could be switched with magnets 3220, or could be magnets themselves. In a preferred embodiment, magnet attractors 3210 are magnets, and magnets 3220 are electromagnets. A remote control (not shown) could then reverse the polarity of magnets 3220 to “eject” the component from the receiver when maintenance needs to be performed. Alternatively, a wire (not shown) could run to the front of component 3030 and surround magnet attractors 3210 so that when a current is applied to the wire, the magnet attractors 3210 reverse polarity to “eject” the component from the receiver.

Component 3030 has electrical male connectors 3230 that are banana jacks that are sized, spaced, and oriented to mate with electrical female connectors 3240 as component 3030 is being mounted in receiver 3020. Banana couplings are preferred because they provide a particularly robust connection, and it is relatively easy to orient the plug to the jack. Of course, one could use a single plug and jack provided that a proper electrical pathway is established, for example, an RF connector. All other suitable types of connectors are also contemplated, including for example inductive connections (not shown), simple bent wire or other bump connectors (not shown), loudspeaker connectors (not shown), D-sub connectors (not shown), and combinations thereof. It should be appreciated that male connectors 3230 and female connectors 3240 could be switched with one another without departing from the scope of the invention.

Regardless of the type of connectors and manner of providing the electrical connections, it is preferred that the electrical connection is substantially automatic. As the component is mounted in the receiver, the female electrical connectors 3240 should mate with the male electrical connectors 3230 without a separate act. In FIGS. 32A and 32B, as component 3030 is placed within receiver 3020, the magnetic force of magnets 3220 upon magnet attractors 3210 pulls male electrical connectors 3230 into female electrical connectors 3240. Forcing the user to manually mate the connectors in a separate act, whether with a wire nut or otherwise, is thought to be much less preferable.

It should be appreciated that electrical connectors may not need to be installed at all, particularly where the component does not require an electrical connection, for example in the case of a picture frame or a wireless doorbell.

In FIGS. 33A and 33B, instead of using an electromagnet of reversed polarities to eject the component from the receiver, a magnet gripper 3310 could be used with a magnet attractor 3320 to overpower the magnetic force between magnet attractor 3210 and magnet 3220. It should be appreciated that the magnetic force between magnet gripper 3310 and magnet attractor 3320 should be much stronger than the magnetic force between magnet attractor 3210 and magnet 3220. It should also be appreciated that if component 3030 is an electronic device, that magnet attractors 3210 and 3320 should be located well aware of any electrical machinery that would be negatively affected by a strong magnetic force. An additional magnet gripper (not shown), or a single magnet gripper with an additional handle, could be used for a user to pull the component out of the receiver with two hands instead of one.

In FIGS. 34A and 34B, a vacuum gripper 3410 is used instead of a magnet gripper to overpower the magnetic force between magnet attractor 3210 and magnet 3220. Vacuum gripper has a lever 3412 that is attached to suction cup 3414 such that when lever 3412 is activated, air is removed from suction cup 3414. When lever 3412 is pulled while suction cup 3414 abuts the flat surface of component 3030, the absence of air in suction cup 3414 provides a vacuum force that locks vacuum gripper 3410 to the front of component 3030. From that point, a user can simply pull on vacuum gripper 3410 to remove component 3030 from receiver 3020.

In FIG. 35, an indent/detent locking mechanism 3500 generally comprises indents 3510 and detents 3520. Indents 3510 are sized, spaced, and oriented to mate with detents 3520 as component 3030 is being inserted into receiver 3020. Preferably, detents snap into place around indents 3510 without locking into place, so that component 3030 can be pulled out of receiver 3020 without damaging the indent/detent mating. Detent 3520 could also be a push-push latch, so that component 3030 could be disengaged merely by pressing on the front of component 3030. In a preferred embodiment, indents 3510 are male banana jacks and detents 3520 are female banana jacks that provide an electrical communication between component 3030 and receiver 3020 and a locking mechanism between component 3030 and receiver 3020.

In FIG. 36, a compressible locking mechanism 3600 generally comprises a compressible material 3610 that fits in the gap between the rear portion of component 3030 and the receiver 3020. Compressible material 3610 is preferably an elastic polymer or fabric that has a tendency to return to its own shape. The combined elastic forces of compressible material 3610 and the vacuum force of pushing air out of receiver 3020 holds component 3030 in place within receiver 3020. In this particular example, the outside face plate 3620 is larger than the rear portion of component 3030.

In FIGS. 37A and 37B, show a sliding bolt locking mechanism 3700 that generally comprises sliding bolts 3710 in component 3030 and recesses 3720 in receiver 3020. Sliding bolt 3710 is a magnet attractor that is pulled into place by drawing magnet 3730 across the surface of component 3030. In this particular example, component 3030 has a handle 3740 that extends from a front surface of component 3030 to allow a user to pull component 3030 away from receiver 3020 once the sliding bolt mechanism is unlocked.

In FIGS. 38A-38D, a pivoting latch locking mechanism 3800 generally comprises pivoting latches 3810 in component 3030, latch lock 3920 in receiver 3020, and magnet attractor 3830 in component 3030. As component 3030 is inserted into receiver 3020, pivoting latches 3810 pivot into a recess (not shown) in component 3030 and then snap into latch locks 3820, preventing component 3030 from being pulled out of receiver 3020. Latch lock 3820 is shown as a beveled recess, but could be a protrusion or any other suitable latch lock that prevents component 3030 from being pulled out of receiver 3020. Here, pivoting latches 3810 are also made of a magnet attracting material. When magnet gripper 3310, shown in FIG. 33A, is applied to magnet attractor 3830, magnet attractor 3830 acts as a magnet, pulling latches 3810 out of latch locks 3820, so that component 3030 can then be pulled out of receiver 3020.

In FIGS. 39A-39C, a screw locking mechanism 3900 generally comprises screws 3910, screw holes 3920 in receiver 3020, and a cover 3930. Screws 3910 are threaded and run through the entirety of component 3030 and into screw holes 3920 to hold component 3030 against receiver 3020. It should be appreciated that screws 3910 could also be angled towards a closer wall of receiver 3020, or could be fully threaded along the entire length of the screw. As seen in FIG. 39B, the heads of screws 3910 are visible from the front of component 3030. Thus, after installation, cover 3930 is positioned in the recess, and magnetically, mechanically or otherwise held in place to provide an even front surface to component 3030.

In FIGS. 39D-39E, the screw locking mechanism 3900 also has a magnetic faceplate 3935 with magnet attractor 3940 and magnets 3950. Magnets 3950 hold the faceplate against component 3030 by coupling to the heads of screws 3910. It should be appreciated that component 3030 could comprise other magnet attractors that help couple the magnetic faceplate to the component. Faceplate 3935 could be removed with either a magnet gripper 3310, as shown in FIG. 33A, or another suitable gripping device, for example a vacuum gripper.

As shown in FIG. 39F, faceplate 3935 could also be held in place and removed using matching indents 3960 and spring detents 3970 to form a push-push mechanical coupling. While the faceplate coupling also preferably conceals the locking mechanism, all other suitable couplings are contemplated. In all of the embodiments, the receiver is preferably preinstalled in a panel that is then installed in a wallboard to provide better support for the component.

In FIG. 40, a panel 4040 is used to mount a component 4020 to a wallboard (not shown). Generally, panel 4040 has an opening 4042 and recessed projections 4044. Front receiver 4030 and rear receiver 4031 clamp onto recessed projections 4044, and then component 4020 could be placed within the completed receiver. Lastly, component cover 4010 is placed over component 4020 to cover at least a portion of the front of component 4020.

Recessed projection 4044 projects into opening 4042, and is also slightly recessed from the front side of the panel. Recessed projection preferably extends more than 1 cm, 2 cm, or 4 cm into the opening but can extend a lesser distance depending on the strength of the panel. Recessed projection is also preferably recessed by about 1 cm from the front side of the panel, allowing ample room for the front receiver to be situated within the opening. Here, recessed projection has screw holes 4046 that help front receiver 4030 and rear receiver 4031 clamp onto the recessed projection, although screw holes are not necessary for front receiver and back receiver to clamp onto the recessed projection.

Front receiver 4030 has an outer perimeter spackling rim 4032 that rests against recessed projection 4044 within the recess formed by recessed projection 4044. Front receiver 4030 has threaded screw holes that are spaced approximately 2 cm from the corners of spackling rim 4032 and are approximately 3 cm deep, but can be shaped and configured in other suitable ways. Screws thread through screw holes in rear receiver 4031 and into the screw holes in front receiver 4030 to “clamp” the front receiver and rear receiver to the recessed projection, holding the receiver in place within the opening. After the receiver is situated, a component 4020 can be fitted into receiver 4030. While front receiver has a receiving portion that accepts component 4020 and rear receiver merely acts as a “rim” that clamps front receiver and rear receiver against the recessed projection, rear receiver could also have a receiving portion that accepts the component without departing from the scope of the invention.

Component 4020 is used euphemistically to refer to any suitable component in any category, for example plasma screens, in-wall art panels, in-wall cabinets, windows, wall outlets, security systems, fuse boxes, light switches, lighting, sprinkler systems, smoke detectors, and so forth. Here, component 4020 is represented by a thin wafer that fits within receiver 4030.

Component cover 4010 covers at least a portion of the front of component 4020, and is preferably held in place with a magnetic coupling system that couples the component cover either directly to the component or to the receiver. Component cover 4010 preferably also rests inside the recess formed by recessed projection 4044 so that the front of component cover 4010 is flush with the front of spackling rim 132. While component cover is shown as a substantially rectangular plate, component cover could be shaped and sized in any manner without departing from the scope of the invention.

A logo opening 4058 and logo recessed projection 4059 are situated below opening 4042 so that a logo front receiver 4050 and logo rear receiver 4055 could couple to recessed projection 4059. Logo 4054 could then be coupled to receiver 4050 using threaded screw 4052. Logo 4054 is preferably flush with the front of logo spackling rim 4051. This way, a logo of a manufacturer could be embedded directly into the panel instead of to the component cover.

In FIG. 41, the panel, receiver, component, and component cover of FIG. 40 have all been coupled together. While component cover 4010 masks the entire component from view, smaller or partial component covers are contemplated that only mask a portion of the component. Such component covers are needed when users need constant access to the component, for example when the component is a speaker or a tough screen of some sort.

In FIG. 42, a horizontal cross-section of constructed panel 4040 has front receiver 4030 and rear receiver 4035 coupled to panel 4040 with screw 4038. Component cover 4010 is locked to component 4020 with magnet attractors 4210 and magnets 4220. Magnets 4220 pull component cover 4010 into component 4020 so that the front portion of component cover 4010 is flush with spackling rim 4032. While magnets 4220 do not have to be particularly strong, magnets 4220 are preferably strong enough to pull component cover 4010 into the locked position when magnets 4220 are less than 5 inches (12.7 centimeters), 2 inches (5.08 centimeters), or 1 inch (2.54 centimeters) from magnet attractors 4210. It should be appreciated that magnet attractors 4210 could be switched with magnets 4220, or could be magnets themselves. Additionally, magnets 4220 could be located within the front receiver or within the panel instead of being in the receiver, and do not need to be physically abutting magnet attractors 4210 when component cover 4010 is mounted. In fact, magnets 4220 could be in any suitable location so long as they attract magnet attractors 4210 when component cover 4010 is placed within the recess.

In a preferred embodiment, magnet attractors 4210 are magnets, and magnets 4220 are electromagnets. A remote control (not shown) could then reverse the polarity of magnets 4220 to “eject” the component cover from the receiver when maintenance needs to be performed. Alternatively, a wire (not shown) could run to the front of component cover 4010 and surround magnet attractors 4210 so that when a current is applied to the wire, the magnet attractors 4210 reverse polarity to “eject” the component cover from the receiver.

A variety of other methods could be used to “pry” component cover off of receiver 4020. For example, in FIGS. 43A and 43B, instead of using an electromagnet of reversed polarities to eject the component from the receiver, a magnet gripper 4310 could be used with magnet attractors 4210 to overpower the magnetic force between magnet attractor 4210 and magnet 4220. It should be appreciated that the magnetic force between the magnet gripper and magnet attractors should be much stronger than the magnetic force between the magnet attractor and the magnet in the receiver. It should also be appreciated that if component 4020 is an electronic device, that magnet attractors 4210 and 4320 should be located well aware of any electrical machinery that would be negatively affected by a strong magnetic force. An additional magnet gripper (not shown), or a single magnet gripper with an additional handle, could be used for a user to pull the component out of the receiver with two hands instead of one.

In FIGS. 44A and 44B, a vacuum gripper 4410 is used instead of a magnet gripper to overpower the magnetic force between magnet attractor 4210 and magnet 4220. Vacuum gripper has a lever 4412 that is attached to suction cup 4414 such that when lever 4412 is activated, air is removed from suction cup 4414. When lever 4412 is pulled while suction cup 4414 abuts the flat surface of component 4020, the absence of air in suction cup 4414 provides a vacuum force that locks vacuum gripper 4410 to the front of component 4020. From that point, a user can simply pull on vacuum gripper 4410 to remove component 4020 from receiver 4020.

In FIG. 45, an indent/detent locking mechanism 4500 generally comprises indents 4510 and detents 4520. Indents 4510 are sized, spaced, and oriented to mate with detents 4520 as component cover 4010 is being inserted into receiver 4030. Preferably, detents snap into place around indents 4510 without locking into place, so that component cover 4010 can be pulled out of receiver 4030 without damaging the indent/detent mating. Detent 4520 could also be a push-push latch, so that component cover 4010 could be disengaged merely by pressing on the front of component cover 4010.

In FIGS. 46A-46C, an alternative indent/detent locking mechanism 4600 generally comprises indents 4610, 4612 and detents 4620, 4622. Detent 4622 is connected to a spring or is made of a compressible material that regains its shape after it is deformed. In this manner, an installer can merely insert detent 4620 into indent 4610, and then push component cover 4010 into the recess. As component cover 4010 is pushed into the recess, detent 4622 compresses until it is adjacent to indent 4612, at which point it snaps back into shape. An unlocking jimmy 4630 or a similar device could then be inserted between detent 4622 and the front receiver to compress detent 4622 and remove component cover 4010.

Many other suitable component cover locking mechanisms could also be used. The component cover locking mechanisms of FIGS. 42-46 have been provided for example only, and should not be considered the only methods to lock component covers into the recess.

FIGS. 47-49 depict alternative panel assemblies that are designed for specific components. FIG. 47 depicts an alternative panel assembly designed for a light switch with a component cover 4710, a dust guard 4720, a light switch 4730, a front receiver 4740, a panel 4750, and a rear receiver 4760. Rear receiver 4760 receives light switch 4730 instead of front receiver 4740. Additionally, logo 4712 is imprinted directly on component cover 4710 so that a separate opening does not need to be opened in panel 4750. Similarly, FIG. 48 depicts an alternative embodiment designed for a power outlet with a component cover 4810, dust guard 4820, power outlet 4830, front receiver 4840, panel 4850, and rear receiver 4860. Screws 4822 are used to couple dust guard 4820 to front receiver 4840, screws 4832 are used to couple power outlet 4830 to front receiver 4840, and screws 4862 are used to couple rear receiver 4860 to front receiver 4840.

FIG. 49 depicts yet another alternative panel assembly designed for a heating, ventilating, and air conditioning (HVAC) unit (not shown), having a component cover 4910, front receiver 4920, spacer 4930, panel 4940, rear receiver 4950, and air vent 4960. Component cover 4910 acts as a vent for the HVAC unit (not shown), and is recessed within the opening of front receiver 4920, rear receiver 4950, and air vent 4960 to provide an air pathway from the air vent to the component cover. Neither receiver receives a component, since the HVAC unit is remote from the location of the vent.

In FIGS. 50A-50B, a prior art power outlet 5000 is generally mounted to a structural barrier 5030, and has a face plate 5010 with one or more female electrical connectors 5020. As used herein, the term “to” with respect to mounting of an object with respect to a structural barrier should be interpreted generically as including instances where the object is being mounted “on”, “onto”, “on top of”, or “in” the structural barrier, unless the context dictates otherwise.

Face plate 5010 has a flange that is mounted over the female electrical connectors 5020 to fit over an opening (not shown) in structural barrier 5030, and rest on the structural barrier's surface. This causes face plate 5010 and female electrical connectors 5020 to protrude slightly outward from the surface of the structural barrier, as can be seen in FIG. 50B, giving the face plate a curved prominence. It should be appreciated that power outlet 5000 is used euphemistically to represent any mounted component in the category of power and data interfaces, for example Ethernet ports, A/V jacks, telephone jacks, and fiber optic jacks.

In FIGS. 51A-51B, a prior art touch screen 5100 is generally mounted to a structural barrier 5130 using screen mount 5140, and has a face plate 5110 and a screen 5120. This causes both face plate 5110 and screen 5120 to protrude outward from the surface of the structural barrier. It should be appreciated that touch screen 5100 is used euphemistically to refer to any mounted component in the category of controllers, including, for example, dimmers, flip-switches, keypads, thermostats, and push-push switches.

Touch screen 5100 has a different familial appearance from power outlet 5000, since both are mounted to the wallboard in different ways and don't share any distinguishing characteristics. For example, both power outlet 5000 and touch screen 5100 are substantially rectangular, and protrude from the wall. But those are not distinguishing features because they are commonplace, and therefore would not serve to distinguish those components as being ones that belongs in a given family of products.

In FIGS. 52A-52B and FIGS. 53A-53B, the face plates of power outlet 5000 and touch screen 5100 have been modified to have a “common familial appearance.” Here, power outlet 5200 has a face plate 5210 that fits over female electrical connectors 5020, but in this case power outlet 5200 rests within a recess in structural barrier 5030 so that the front surface of face plate 5210 and female electrical connectors 5020 are flush-mounted relative to the front surface of structural barrier 5030. As such, the face plate has little or no prominence from the wall. Additionally, face plate 5210 has a distinctive logo 5220 that identifies the manufacturer of the face plate. In this case, the logo is the Trufig™ trademark, which comprises a square with a capitalized T within the square.

The face plate of touch screen 5300 has similar modifications. Face plate 5310 fits over screen 5120, but is disposed within a recess in structural barrier 5130 so that the front surface of face plate 5310 and screen 5120 are flush relative to the structural barrier 5130. Face plate 5310 also has a logo 5320, which is once again the Trufig™ trademark. It should be noted that either or both of the flush-mount modification and the addition of a logo provides the components with a “common familial appearance.”

Any suitable method of obtaining a common familial appearance is contemplated. For example, different types of components could have a common distinctive polygonal or elliptical shape (e.g., ovals, stars, triangles, pentagons, circles) or cross-section. The distinctive polygonal or elliptical shape could be formed by the component itself, or preferably by a face plate attached to a front surface of the component. Polygonal shapes could also be added as a pattern or a logo on the face plate itself. For example a border of a set of face plates could comprise lines of stars, and that feature could provide a common familial appearance to the corresponding components. As mentioned above, rectangular and round shapes are not considered to be sufficiently distinctive, in and of themselves, to establish a common familial appearance. As defined herein, a “rectangular shape” does not need to be perfectly rectangular. Rectangular shapes include shapes that are substantially rectangular, for example by having rounded corners, or by having opposing sides that are not perfectly parallel.

Non-geometric shapes of face plates are contemplated to be sufficiently distinctive to establish a common familial appearance. For example, hearts, letters, numbers, logos, and combinations thereof can establish a common familial appearance. Indeed, there are families of light fixtures that include moon shapes, star shapes, rocket ship shapes, and so forth, but in that case the components are all in the same category, namely light fixtures. To the best knowledge of the inventor(s) herein, it is not known for that family to extend to other categories, namely speakers, controllers, air vents, power/data interfaces, fire response devices, cabinetry, or cameras.

Alternatively or additionally, the front of components (or their corresponding face plates) could achieve a common familial appearance by having a unique prominence from the wall. As defined herein, a “prominence” is a projection or a recess of a noticeable distance from a wall. By way of example, contemplated prominences are a concave pattern, a convex pattern, a wavy pattern, a protruding three-dimensional logo, and a recessed engraving. The visual cues that compose the common familial appearance do not need to be the same size and magnitude, and can indeed merely be proportional to one another.

Other visual cues can also be used, for example by covering a surface of the component with a certain color, finish, pattern or combination thereof. For example, a familial appearance could be a face plate that protrudes out in a convex arc from the surface of the structural barrier. Or a combination of logos with specific colors could be engraved into the front surface of the component. Combinations of a prominence, a color, and a finish are especially preferred.

Contemplated distinctive common familial appearances include a fire alarm or sprinkler that is non-round (i.e. square, rectangular, triangular, rhomboid, pentagonal) or power outlets or data outlets with a front surface that is flush with a front of the wallboard. Preferably, devices that do not require interaction with a user, for example fire response devices, speakers, and cameras, are flush with the surface of the wallboard and is largely camouflaged or hidden from view. For example, a fire sprinkler could be hidden behind a flush face plate that pops off when the sprinkler activates, or a camera could be placed behind a dark one-way glass in the midst of a black ceiling. Face plates and mount shapes are especially preferred when they vary from the traditional shapes that are used in the prior art.

While FIGS. 52A-52B and 53A-53B only show a controller component and a power/data interface component sharing the same common familial appearance, any number of components (or their face plates) from any number of categories could be designed to have a common familial appearance. For example, light switches, power outlets, speakers, and cabinetry for an entire wall of a building, or indeed an entire building, could share a common familial appearance.

In FIG. 54 a panel assembly 5410 and 5420 have been installed in a structural barrier 5430 and 5440, and to studs 5432 and 5442, respectively. This allows for three components to be installed into opening 5450, 5452, and 5454. Panel assembly 5410 and 5420 are from the same family and have identical openings that accept a variety of different components from different categories. By way of example, a flush-mount wall outlet could be installed in opening 5450, a flush-mount control panel could be installed in opening 5452, and a flush-mount television could be installed in opening 5454, and all would have the same common familial appearance of having a front surface that is completely flush with the surface of the structural barrier. This flush-mount surface would be distinctive from other wall-mounted components and gives the entire room a unified appearance.

Thus, specific embodiments of systems, methods, and apparatus for installing wall components into a wallboard have been disclosed. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A panel for facilitating installation of a component into a wallboard, comprising:
an opening in the panel that receives the component;
a spackle rim disposed about the opening; and
a gradient extending from the spackle rim outwards along the panel, wherein the panel has a thickness within 10% of a wallboard thickness.

2. The panel of claim 1, further comprising a receiver coupled to the opening, wherein the receiver comprises the spackle rim.

3. The panel of claim 1, further comprising a spackle shield that prevents spackle from entering the opening.

4. The panel of claim 1, further comprising a laser leveler that indicates spackle component that extends from a surface of the wallboard.

5. The panel of claim 4, wherein the laser leveler rotates about an axis.

6. The panel of claim 1, wherein the spackle rim has a first edge and a second edge, wherein the gradient extends from each of the first and second edges.

7. The panel of claim 1, wherein the gradient is linear.

8. The panel of claim 1, wherein the gradient is curved.

9. The panel of claim 1, wherein the gradient has a greatest height of less than 5 mm.

10. The panel of claim 1, wherein the gradient has a greatest height of less than 3 mm.

11. The panel of claim 1, wherein the gradient extends from the spackle rim by at least 20 mm.

12. The panel of claim 1, wherein the gradient extends from the spackle rim by at least 50 mm.

13. The panel of claim 1, further comprising a stud attachment designation.

14. A method of installing a wall component into a wallboard, comprising the following steps:
providing a panel with a spackle gradient extending from a spackle rim outwards along the panel, wherein the spackle rim is disposed about a panel opening in the panel;
installing the panel into a wallboard opening in the wallboard; and
spreading a spackle component across the spackle gradient and the wallboard to maintain a superficially continuous surface from the wallboard to the spackle rim.

15. The method of claim 14, wherein the step of spreading the spackle component comprises spreading flattening a front surface of the spackle component to be substantially even with a surface of the wallboard.

16. The method of claim 14, further comprising activating a laser leveler and aiming a laser light from the laser leveler in a direction substantially perpendicular to a front surface of the wallboard.

17. The method of claim 16, further comprising rotating the laser leveler along a path that is substantially perpendicular to the front surface of the wallboard.

18. The method of claim 14, further comprising covering the panel opening with a spackle shield prior to spreading the spackle component.

19. The method of claim 14, further comprising coupling the wall component with the panel opening

20. The method of claim 14, further comprising coupling the wall component to a receiver disposed within the panel opening.
